(19) United States
(12) Patent Application Publication
(10) Pub. No.: US 2024/0299232 A1
(43) Pub. Date: Sep. 12, 2024

(54) AMBULATION AID FORMED FROM AIR-INFUSED PARTICLES

(71) Applicant: MOTIVO, INC., Franklin, WI (US)

(72) Inventors: Jeremy Frank Knopow, Burlington, WI (US); Jennifer Ruth Harris, Milwaukee, WI (US); Peter Morris, Franklin, WI (US)

(21) Appl. No.: 18/573,824

(22) PCT Filed: Jun. 23, 2022
(86) PCT No.: PCT/US2022/034758

§ 371 Date: Dec. 22, 2023

Related U.S. Application Data
(60) Provisional application No. 63/214,248, filed on Jun. 23, 2021.

(51) Int. Cl. A61H 3/04; A61H 3/00

(52) U.S. Cl. CPC A61H 3/04; A61H 2003/004; A61H 2003/046; A61H 2201/0161; A61H 2201/1633

(57) ABSTRACT

Ambulation aid apparatus, mechanisms, methods of configuration and use, methods of manufacture, and articles of manufacture are disclosed. An example ambulation aid apparatus formed of a collection of fused particles with entrapped air is disclosed.

### CROSS-REFERENCE TO RELATED APPLICATIONS

This patent arises from U.S. Provisional Patent Application Ser. No. 63/214,248, which was filed on Jun. 23, 2021. U.S. Provisional Patent Application Ser. No. 63/214,248 is hereby incorporated herein by reference in its entirety. Priority to U.S. Provisional Patent Application Ser. No. 63/214,248 is hereby claimed.

### FIELD

The present field of invention relates to ambulation aids, and more specifically to an ambulation aid formed as an integral part from air-infused particles.

### BACKGROUND

A range of ambulation aids have been developed over the many years since these devices were first introduced. These devices are used to assist people in the act of walking or standing by providing weight bearing and/or balance assistance. Historically, the basic construction method has changed little, with the vast majority being constructed of extruded metal tubing. A smaller percentage of devices have been constructed of assembled polyvinyl chloride (PVC) plumbing pipe, hydroformed metal, or occasionally injection molded polymer parts.

In either case, multiple pieces (e.g., multiple tubes) must be assembled to create a frame on which one or more supports can be provided to aid in user mobility. Such tubular frame-based assemblies are complex to manufacture and assemble and suffer from multiple joinders and other contact points. Additionally, the tubular frame creates an undesirable aesthetic. Further, an excessive amount of time and multiple processes may be required in assembly.

Current construction techniques only offer a limited range of engineering and design flexibility. This is due to the nature of the materials used, as well their method of manufacturing and construction. Designs based on tubular materials are limited by factors such as the availability of stock materials, bend radii of the tubes, how the tubes are joined at intersections, weight of the tubes, strength of the tubes, the overall shape and form of the cylindrical materials, etc. Hydroformed metal construction allows for more design flexibility than tubular materials, but the nature of the hydroforming process and the materials used are expensive and can quickly place the ambulation aid out of the price range of most users. Injection molded polymer construction can offer yet more design flexibility than hydroformed metal, but the geometry required to make the parts strong enough for use result in an overly heavy part. In addition to the weight disadvantage, all of the structural ribbing required to make an injection molded solid polymer part strong enough for use results in a part that is generally unattractive on at least one side, while all of the cracks and crevices also make it difficult to clean.

### BRIEF DESCRIPTION OF THE DRAWINGS

A clear conception of the advantages and features constituting the present invention, and of the construction and operation of typical mechanisms provided with the present invention, will become more readily apparent by referring to the example, and therefore non-limiting, embodiments illustrated in the drawings and photos accompanying and forming a part of this specification, wherein like reference numerals designate the same elements in the several views, and in which:

FIGS. 1A-F illustrate views and variations of an example ambulation aid.

FIGS. 2A-B illustrate an example implementation of the seat panel of the ambulation aid of FIGS. 1A-F.

FIGS. 3A-D depict example states or configurations of the seat panel and storage door panel of the example of ambulation aid of FIGS. 1A-F.

FIG. 4 illustrates an example hinge and latch mechanism connecting panels of the example ambulation aid of FIGS. 1A-F.

FIGS. 5A-5B illustrate an example handle mechanism of the example ambulation aid of FIGS. 1A-F.

FIG. 6 illustrates an example brake mechanism of the example ambulation aid of FIGS. 1A-F.

FIG. 7 illustrates a transparent view of the example ambulation aid of FIGS. 1A-F showing embedded inserts formed in the panels of the example ambulation aid.

FIG. 8 illustrates a flow diagram of an example method to manufacture the example ambulation aid of FIGS. 1A-F.

FIGS. 9-35 illustrate a plurality of views of an ornamental appearance of an example ambulation aid.

### DETAILED DESCRIPTION OF CERTAIN EMBODIMENTS

Certain examples provide an ambulation aid, otherwise referred to as a rollator or walker. In certain examples, a crutch and/or cane is also considered an ambulation aid. Certain examples provide a lightweight, stable, and sturdy ambulation aid that supports user body weight, enables user mobility, is easy to maneuver, and is easy to lift, carry, and store. Certain examples provide method of manufacturing the ambulation aid using an air-infused material, such as steam chest molding of air-infused particles into an integral ambulation aid body of foam, other air-infused material, etc. Certain examples enable a user to walk within the frame of the ambulation aid, rather than behind the ambulation aid (as in traditional walker designs), improving stability and comfort while reducing a risk of falling. Certain examples provide additional functionality to a user beyond the capabilities of a traditional metal tubular walker.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore, provided to describe one or more example implementations and not to be taken limiting on the scope of the subject matter described in this disclosure. Certain features from different aspects of the following description may be combined to form yet new aspects of the subject matter discussed below.

The figures are not necessarily to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts.

Descriptors “first,” “second,” “third,” etc., are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

As used herein, the terms “system,” “unit,” “module,”, “engine,”, “component,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, or system may include a hard-wires device that performs operations based on hard-wired logic of the device. Various modules, units, engines, and/or systems shown in the attached figures may represent the hardware that operates based on software or hardwired instructions, the software that directs hardware to perform the operations, or a combination thereof.

In certain examples, the ambulation aid provides improved stability, mobility, and functionality over previous walker designs. For example, with a traditional rolling walker, its fixed seat forces a user to walk behind the seat with their spine forward and bent, leaving the user in a hunched over position. Certain examples provide an ambulation aid with a stow-away seat to open space within the walker to allow the user to walk inside the walker, aligning the spine and enabling the user to walk upright, reducing back and neck pressure by up to 60%. Additionally, through a wheeled design and allowing the user to stand within the span of the ambulation aid, a zero-degree turn radius is provided, enabling maneuverability into tight spaces, around corners, quicker reaction to obstacles, etc. Also allows for reducing the distance a user must reach over a walker when trying to access a countertop or sink, often resulting in the user dangerously putting their walker to the side to reach what they need and leaving them without the surrounding support of their walker. A brake further enables the ambulation aid to be readily controllable on inclines, when faced with obstacles, etc. Additional features can include cup holder(s), a movable tray, a storage compartment, etc.

Certain examples provide an ambulation aid formed of foam or a foam-like material that is generated from a plurality of air-infused particles. The body of the ambulation aid provides integral support for a user through the ambulation aid body, rather than traditional, multi-segmented walker design. In certain examples, the ambulation aid body is formed using a manufacturing process such as a molding process (e.g., steam chest molding, etc.), which forms the ambulation aid body from a collection of air-infused particles.

For example, using a steam-chest molding process, the ambulation aid can be formed from a plurality of molded beads, balls, spheres, and/or other particles, such as expandable polystyrene (EPS), expanded polyethylene (EPE), expanded polypropylene (EPP), expanded polylactide (EPLA), expanded thermoplastic polyurethane (ETPU), etc. These air-infused particles may expand or maintain their size under heat and pressure, for example. Some such particles may be formed with internal pressure to assist in fusion of particles to form an integral part via a manufacturing process such as steam-chest molding, etc. Steam-chest molding is a manufacturing process to form a foam or foam-like structure from a plurality of balls or beads (also referred to as air-infused particles or particles having entrapped air) that are placed in a receptacle or mold at a certain volume and treated with steam.

An example mold includes vents integrated into the surface(s) of the mold to facilitate introduction and evacuation of steam, pressure, etc. The mold can be associated with injectors to provide particles, steam, pressure, etc., and ejectors to eject the part after molding is complete. In certain examples, the formed part can be cured in an oven or other heated chamber.

In operation, the steam transforms the particles into a combinable state. For example, the steam can cause the particles to expand under vacuum and pressure. The steam heats the particles into a fusible state, for example. Pressure can be applied to fuse the particles into an integral foam/foam-like part. Vacuum is used to extract air and steam that may otherwise cause unwanted bubbles or pockets to form in the part. In certain examples, steam, pressure, and/or vacuum is applied to a mold in both directions to help ensure intended bead/particle fusion and/or expansion into the formed part.

Pressure applied to the heated, and sometimes expanded, particles (e.g., compressible beads) can vary based on a desired density of the resulting integral part. For example, lighter pressure results in a less dense foam or other air-infused material, while heavier pressure forms a more dense structure. In other examples, density is determined by the construction, composition, and/or size of the starting particle.

In certain examples, molding may include variable density to form portions or areas of different density in the same part. The configuration of the part for variable densities can be based on a load-bearing analysis, etc. For example, regions of the part are temporarily separated as the regions are processed. Each region is associated with a different desired density, which can be achieved through different material, different particle concentration, different pressure, etc. After processing each region, the regions are fused together into one part within the same molding operation. As such, the part can be more precisely formed to include areas of greater and lesser strength depending upon the configuration of the part. Such variable density results in savings of material, cost, and part weight while increasing part utility and function.

In certain examples, pressure applied in the mold to form the integral part also creates a barrier or “skin” on the exterior portion of the foam other air-infused material (e.g., the part(s) of the material contacting the interior surface of the closed mold). The skin provides a barrier against the entry of moisture into the formed part and provides added rigidity to the integral part without necessitating a coating of additional material, for example.

In certain examples, the formed part is cooled (e.g., by introducing cooling water or air into the mold to cool and cure the formed part, by cooling the mold itself, etc.). Pressure can be maintained until the part is cured to avoid unwanted expansion or bloating of the part during cooling and curing. If cooling liquid used, that cooling liquid is ejected from the mold, and then the formed part can be ejected or otherwise removed from the opened mold. In certain examples, molds can be heated to maintain temperature in between cycles of the molding process, which reduces cycle times to prepare and maintain the mold.

In certain examples, components can be integrated into the body of the ambulation aid as part of the steam-chest molding process. In certain examples, reinforcements, stiffening materials, attachment points, and/or other elements (referred to as inserts), can be positioned in the mold/receptacle before the beads are introduced. As the material expands and/or otherwise combines under steam and pressure, the air-infused material forms around the elements inserted in the mold. As such, an attachment point for a tray, seat, handle, etc., can be integrated into the body of the ambulation aid in the steam-chest molding process, for example.

Thus, a monolithic part can be formed as the body of an ambulation aid. In certain examples, the part is of uniform density. In other examples, density of the part varies throughout as stiffeners, reinforcements, attachment points, etc., increase the density of the foam/other air-infused material part at various locations. Inserts, attachment points, etc., can be injection molded and then inserted into the steam chest mold to be integrated into the steam chest molded foam/other air-infused material body of the ambulation aid, for example. As such, the steam-chest molded foam/other air-infused material can be lightweight, strong, durable, semi-rigid, etc., while plastic insert(s) are rigid, rubber insert(s) are flexible, etc. Inserts, additives, etc., introduce different material property(-ies) than the foam or other air-infused material provides.

In other examples, engineered particle foam is used to form the ambulation aid body. In other examples, plastic can be foamed, expanded, or otherwise infused with air to form a structural foam using injection-molded plastic with integrated bubbles formed in the plastic by injecting air to create air bubbles in the plastic through a chemical reaction between the injected air and the plastic (e.g., a chemical foaming agent added to a resin to form an air-infused material, etc.). In other examples, gas-assist injection molding can be used to inject air to create bubbles or hollowed spaces in an injection-molded part. In some examples, an expanding foam, such as a polyurethane rigid foam, can be used. In some examples, a block of foam and/or other air-infused material can be molded, and a computer numerical control (CNC) machine can be used to cut out one or more panels forming an ambulation aid. In some examples, all or part of the ambulation aid can be formed using additive manufacturing.

Certain examples described and disclosed herein relate to ambulation aids, and more specifically to ambulation aids formed in unibody, unitary, monocoque, and/or semi-monocoque construction for simplified manufacture, durable construction, and user support, as well as more pleasing aesthetics and increased design options. For example, an ambulation aid can be constructed of foam, molded polymer material, other air-infused material, etc., allowing for a lightweight, yet strong, customizable, and economically viable solution. The inventive structure also allows for integrated accommodations such as personal storage, seating, height adjustment, walking cane storage, cup holder, tray, and/or the like to be integrated into and/or otherwise attached to the structure.

In certain examples, an ambulation aid apparatus is formed to unify a plurality of structural and/or ornamental features into a single integral part. For example, a body of the example ambulation aid apparatus may be formed of foam or other air-infused material to provide a support frame for the user while also enabling accessories to be provided as part of the ambulation aid. Thus, the ambulation aid body provides structural strength and support while also providing a cosmetic exterior and/or interior for the apparatus in a single integral part (e.g., using steam-chest molding, etc.). The body of the example ambulation aid may also provide integrated mounting and/or attachment point(s) to attach one or more components/subassemblies to the body. For example, one or more aesthetic and/or functional accessories can be attached to one or more surfaces of the part. Such attachment can be permanent, removable, or replaceable. For example, one or more color panels, hooks, lights, body sensors (e.g., electrocardiogram monitor, other biometric sensor, fall detector, global positioning sensor (GPS), etc.), proximity sensor, other alarm, reflectors, oxygen tubes, oxygen tank mounts, batteries, latches, etc., can be (removably) attached to the integral ambulation aid part.

In one example, an oxygen tank can be attached inside a storage compartment of the ambulation aid with guides for an oxygen tube through the compartment for access by the user. In another example, electric wires can be formed in the ambulation aid to enable connection to a battery (e.g., stored in the storage compartment, integrated into the ambulation aid, etc.) and connected to one or more lights, phone charger, sensor, communication, etc. In certain examples, battery power can be used to heat and/or cool the storage compartment, etc.

Certain examples provide an ambulation or mobility aid (often referred to as a “rollator” or “walker”) constructed to allow for a wide range of design and engineering flexibility, while remaining lightweight, strong, and affordable. Certain examples provide a combined body and frame in a single structure (rather than a tubular frame constructed from a plurality of separate but connected tubes and including additional attachments).

In certain examples, the ambulation aid allows a user to store personal items, sit down when necessary or desired, carry a plate of food or other items on a flat surface, etc. The example ambulation aid adjusts to a user's height and provides for the storage of a secondary walking aid such as a cane, cup, purse or other bag, etc. The inventive structure also allows for accommodations such as personal storage, seating, height adjustment, walking cane storage, and a tray to be integrated into the structure.

Certain examples provide an apparatus including an ambulation aid body formed as an integral part, the integral part formed to provide support for mobility of a user through the integral part, the integral part providing a plurality of grippable areas to facilitate user movement and support through the integral part.

In some examples, the ambulation aid body is to be formed as an integral part via a steam chest molding process. In some examples, the ambulation aid body is to be formed from a polymer material, such as balls, beads, pellets, and/or other air-infused particles, that can be fused to form the ambulation aid body. In some examples, the apparatus includes a seat to support a user when in use and to allow the user to walk inside a boundary of the ambulation aid body for support and movement via the ambulation aid body at least when the seat is not in use. In some examples, the apparatus includes a tray to support an item when in use and to allow the user to walk inside a boundary of the ambulation aid body for support and movement via the ambulation aid body at least when the tray is not in use.

In some examples, the plurality of grippable areas include one or more of a handle, an opening, a top of the ambulation aid body, a side of the ambulation aid body, etc. In some examples, the handle is at least one of movably affixed to or incorporated into the ambulation aid body. In some examples, the handle is to be movable with respect to the ambulation aid body to adjust a height of the ambulation aid body with respect to the user.

In some examples, the apparatus includes at least one of a wheel, a post, or a skid affixed to the ambulation aid body to facilitate movement of the ambulation aid body by the user. In some examples, the ambulation aid body includes one or more connections between sections of the integral body to enable the ambulation aid body to be folded, and wherein, when folded, the ambulation aid body is to remain self-standing and movable. In some examples, the ambulation aid body further includes storage, wherein the storage is to retain an item placed in the storage when the ambulation aid body is folded.

Certain examples provide a method of forming an ambulation aid. The example method includes forming, from a supply of moldable material, an ambulation aid body as an integral part via steam chest molding, for example.

In some examples, the method further includes attaching one or more subassemblies to the formed ambulation aid body. In some examples, the one or more subassemblies include a seat to support a user when in use and to allow the user to walk inside a boundary of the ambulation aid body for support and movement via the ambulation aid body at least when the seat is not in use. In some examples, the one or more subassemblies include a tray to support an item when in use and to allow the user to walk inside a boundary of the ambulation aid body for support and movement via the ambulation aid body at least when the tray is not in use. In some examples, the one or more subassemblies include at least one of wheels and a skid affixed to the ambulation aid body to facilitate movement of the ambulation aid body by the user. In some examples, the one or more subassemblies include storage (e.g., a storage compartment), wherein the storage is to retain an item placed in the storage when the ambulation aid body is folded.

Certain examples provide an ambulation aid apparatus. The example ambulation aid apparatus includes a primary panel formed of foam or other air-infused material to provide support for and assist in mobility and stability of a user, the primary panel formed to interrelate with one or more subassemblies to provide an integrated part to assist in providing support for and improved mobility of the user through the integrated part.

In some examples, the one or more subassemblies include a plurality of secondary foam/air-infused material panels, the plurality of secondary panels movably connected to the primary panel to form a body of the ambulatory aid and arranged to provide support, stability, and mobility to a user when the secondary panels are extended in relation to the primary panel. In some examples, connections between the primary panel and the plurality of secondary panels enable the ambulation aid apparatus to be folded, and wherein, when folded, the ambulation aid apparatus is to remain self-standing and movable.

### Example Ambulation Aids

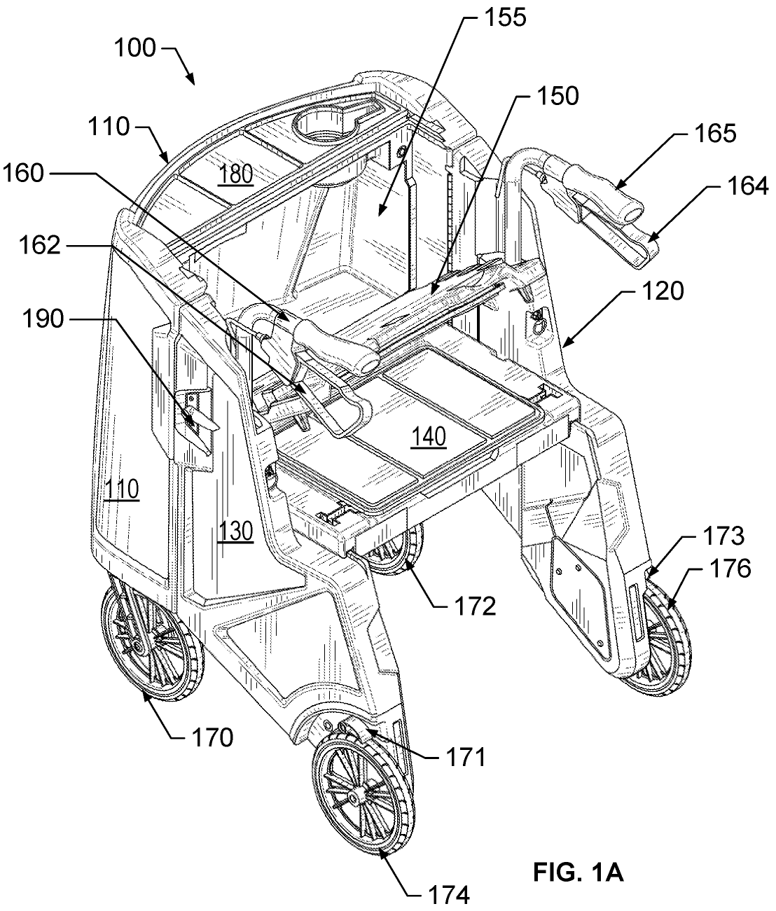

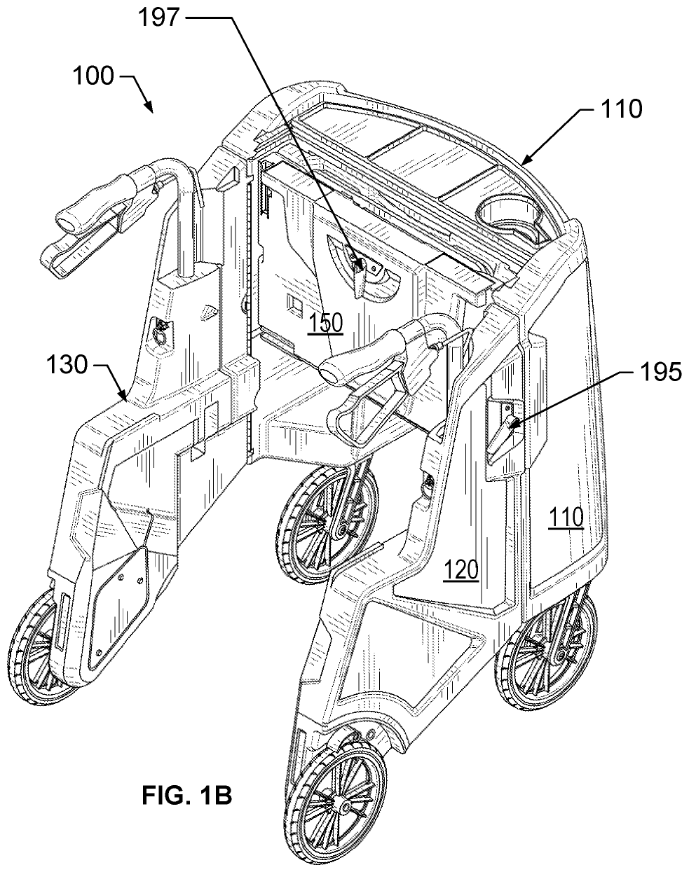

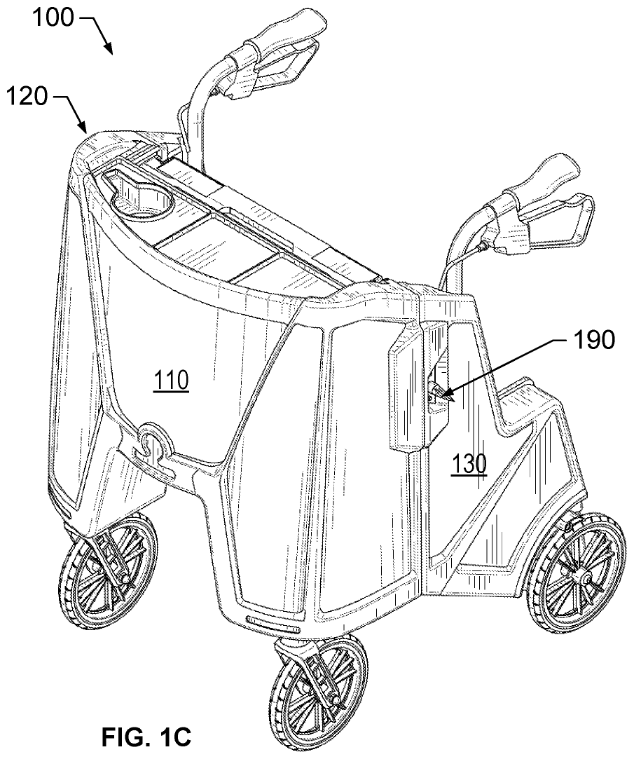

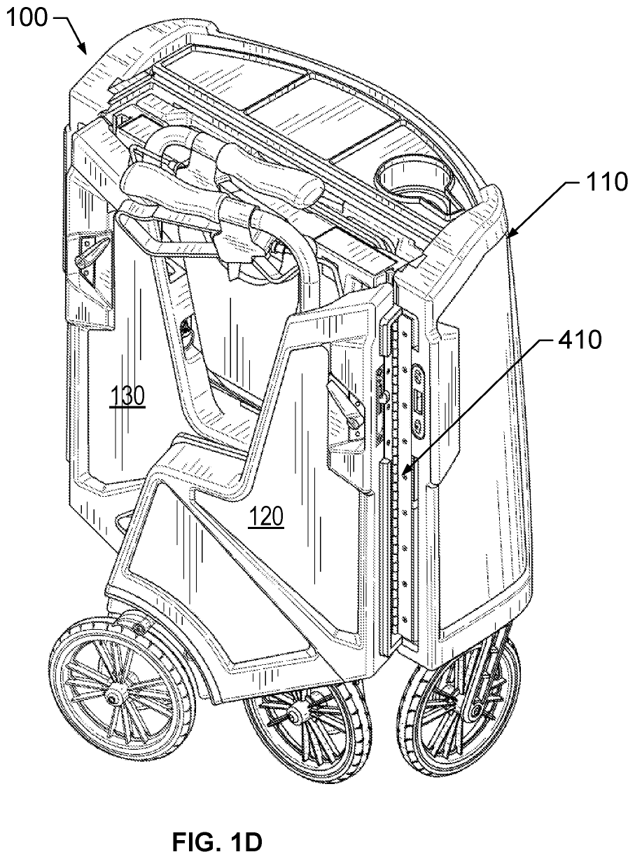

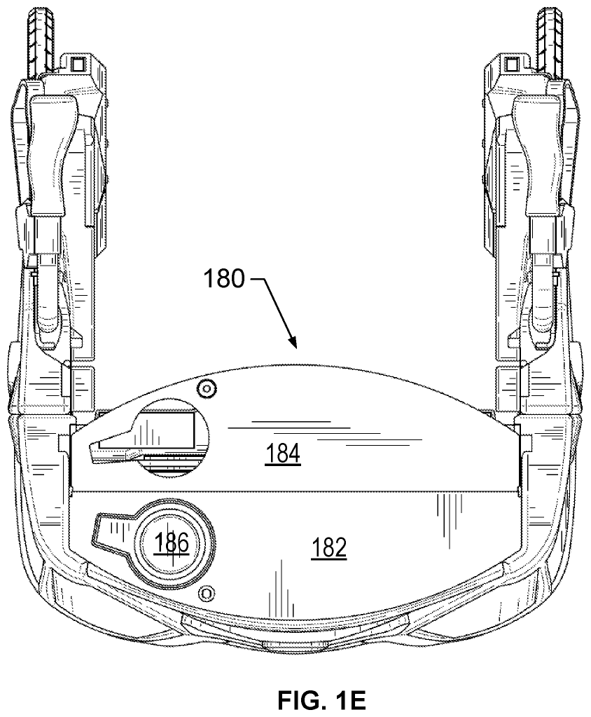

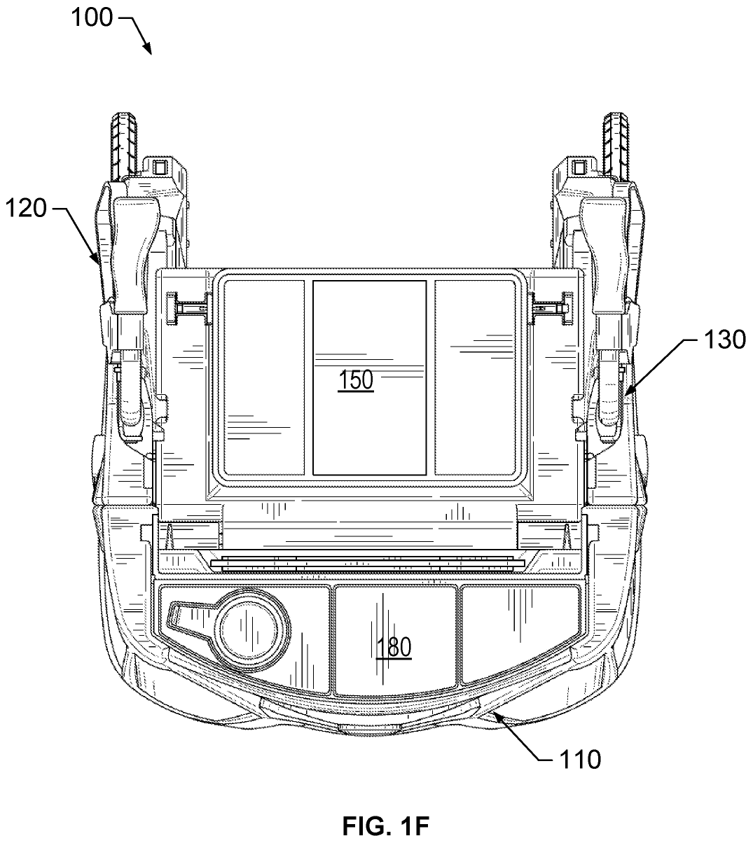

FIGS. 1A-1D illustrate an example ambulation aid 100. The example ambulation aid 100 of FIG. 1A includes a center panel 110, a right panel 120, and a left panel 130, a storage door panel 140, and a seat panel 150. Each of the panels 110-150 can be formed as an integral part using a manufacturing process such as steam-chest molding, etc. For example, each of the panels 110-150 can be formed of foam and/or other collection of fused particles with entrapped air (air-infused particles) using steam-chest molding or other similar technique. A collection of fused particles can be provided to the molding process as a set of hollow or semi-hollow plastic spheres, beads, or balls (e.g., air-infused particles) that interconnect (e.g., are fused together via heat and/or pressure, etc.) to form one or more of the panels 110-150, for example. In certain examples, the air-infused particles expand and are fused to form one or more of the panels 110-150 when exposed to heat and/or pressure. In other examples, the air-infused particles stay substantially the same size (e.g., do not appreciably expand) and are fused to form one or more of the panels 110-150 when exposed to heat and/or pressure. In some examples, the fused collection of air-infused particles forms one or more panels 110-150 of the example ambulation aid 100. In other examples, one or more of the panels 110-150 are carved or milled out of a block of air-infused material.

In some examples, all of the panels 110-150 are formed as foam or other air-infused material using steam-chest molding. In other examples, a subset of the panels 110-150 (e.g., the panels 110-130, etc.) are formed as foam or other air-infused material using steam-chest molding. Other materials and/or other processes, such as injection molding, additive manufacturing, subtractive manufacturing, etc., can be used to form one or more of the panels 110-150, for example. In certain examples, one or more panels 110-150, such as the left, right, and center panels 110-130, can be formed together as a solid contiguous unit or as sections joined by lesser material in the form of a living hinge. For example, a living hinge is a thinner, more flexible section of material formed in the same mold and connecting the right panel 120 to center panel 110 and, similarly, connecting the left panel 130 to the center panel 110 while allowing some movement of the left and right panels 120-130 with respect to the center panel 110.

As shown in the example of FIG. 1A, a storage compartment 155 is formed in the center panel 110 and can be closed or made accessible (e.g., opened) based on the position of the storage door panel 140. When the storage door panel 140 is positioned “up” against the center panel 110, then the storage compartment 155 is closed, and items can be stored in the storage compartment 155. When the storage door panel 140 is opened or positioned down with respect to the center panel 110, then the storage compartment 155 is opened, and items can be removed and/or added to the storage compartment 155.

The example ambulation aid 100 of FIG. 1A also includes a pair of adjustable handles 160-165, wheels 170-176, a foldable tray 180, and latches 190-195. The handles 160-165 include brake levers 162-164 which engage brake shoes 171-173 to lock at least the rear wheels 174-176. The latch 195 is not shown in this view (shown in the example of FIG. 1B) but mirrors the latch 190 shown in the example of FIG. 1A. In certain examples, the foldable tray 180 is movable to double in size and provide additional surface area to a user. For example, the tray 180 folds in place against the center panel 110 for movement, storage, etc., as shown in the example of FIG. 1A. The tray 180 then folds away from the center panel 110 to provide additional surface area for use (e.g., when the ambulation aid 100 is stationary, etc.). The tray 180 can be movable on a hinge (e.g., a hinge, a piano hinge, a door hinge, a drop pin, a living hinge, etc.), for example. The tray

In certain examples, the latches 190-195 lock the side panels 120-130 in position with respect to the center panel 110. When locked in place, the combination of the center panel 110 and the side panels 120, 130 forms a rigid structure to support the user. When unlocked, the side panels 120, 130 can be folded up against the center panel 110 to compact the ambulation aid 100 for storage, transport (e.g., in a vehicle), etc.

FIG. 1B illustrates another view of the example ambulation aid 100. While FIG. 1A shows the seat panel 150 down and the storage door panel 140 open, the example of FIG. 1B shows the seat panel 150 stowed away and the storage door panel 140 closed (no longer visible in the view of FIG. 1B). A latch 197 is used to open (e.g., unlatch and move down) and close (e.g., move up and latch) the seat panel 150 such that the seat panel 150 is secure against the storage door panel 140 and the body of the center panel 110 when latched. As shown in the example of FIG. 1B, when the seat 150 is stowed and the storage door 140 is closed, a user can walk within the confines of the ambulation aid 100 and position themselves up against the closed storage door panel 140, enabling improved posture, reach, and stability with the example ambulation aid.

FIG. 1C is another view of the example ambulation aid 100 showing a front view of the example center/main/primary panel 110, right panel 120, and left panel 130 in an open or extended configuration for movement and use. In this open configuration or mode, also referred to as a mobility configuration or mode, the ambulation aid 100 is configured to support a user for movement, stability, etc. In such a mobility configuration, the right panel 120 and left panel 130 are latched securely (e.g., using the latches 190-195) in extended position with respect to the center panel 110 to support the user.

FIG. 1D shows the example ambulation aid 100 in a folded configuration for storage, transportation, etc., referred to as a storage or transportation mode or configuration As shown in the example of FIG. 1D, in the transportation configuration, the right panel 120 and the left panel 130 are folded in against the center panel 110 to collapse the ambulation aid 100. In the example of FIG. 1D, the left panel 130 is first folded against the center panel 110, followed by the right panel 120 folded against the left panel 130. While this configuration is shown in the example of FIG. 1D, an opposite configuration can be implemented in which the right panel 120 is first folded against the center panel 110, and the left panel 130 is next folded against the right panel 120. As described further below in connection with FIG. 4, an example piano hinge 410 is shown in the view of FIG. 1D.

FIG. 1E illustrates an example configuration of the ambulation aid 100 in which the tray 180 is extended (e.g., folded open or folded out, etc.). As shown in the example of FIG. 1E, the example tray 180 includes a base portion or section 182, which forms a top of the center panel 110, and a movable portion or section 184, which can be moved to rest on top of the base portion 182 or moved away from the base portion 182 to increase a size of the usable tray 180 (e.g., to double a size of the tray 180). The base portion 182 and the movable portion 184 can be connected via a hinge, a living hinge, a pin, etc. The base portion 182 of the tray can also include a cup holder 186, for example. In certain examples, all or part of the tray 180 (e.g., the movable portion 184 and/or both the movable portion 184 and the base portion 182) can be removed (e.g., for replacement, cleaning, etc.) and reinserted.

FIG. 1F is a top view of the example ambulation aid 100 with the seat panel 150 in a downward or open position. In this seated mode or configuration, the seat panel 150 is opened into position such that the user can sit or rest on the seat panel 150.

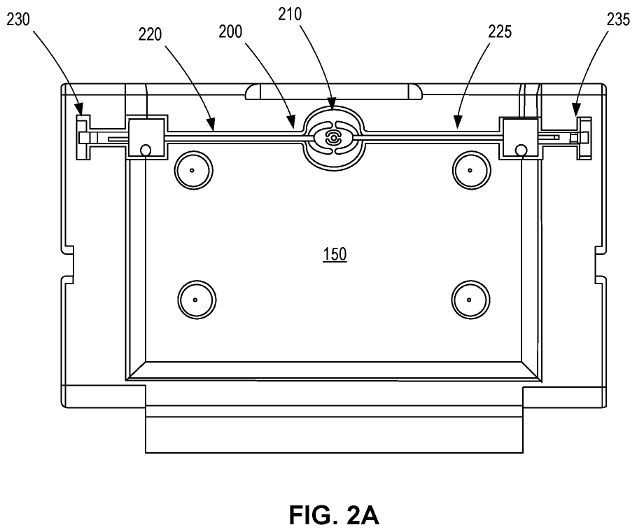

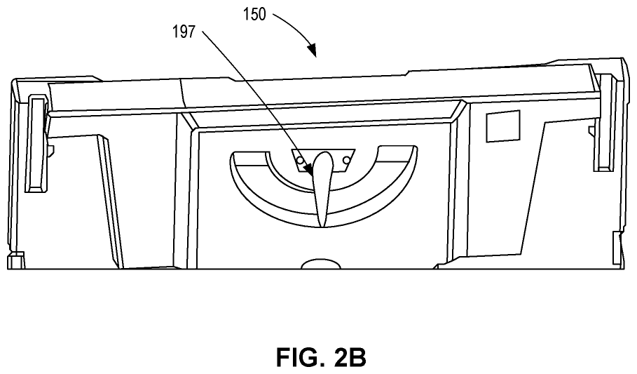

FIG. 2A illustrates an example implementation of the seat panel 150 (e.g., shown without a cover to reveal its latching mechanism) with a latch mechanism 200 including a pivot 210 with members (e.g., metal or plastic rods, shafts, other members, etc.) 220-225 extending to pins 230-235, which secure the seat panel 150 with respect to the storage door panel 140. When the latch or lever 197 (not shown in this view because it is located on the other side of the seat panel 150) is moved in either direction (e.g., left or right), the pivot 210 also moves, shifting its members 220-225 and disengaging the pins 230-235 to move the seat panel 150 from a position against the storage door panel 140 (e.g., into the down or seating position as shown in the example of FIG. 1F). When the latch 197 is released, the pins 230-235 secure the seat panel 150 with respect to the storage door panel 140 when the seat panel 150 is in a raised or stowed position. When the seat panel 150 is down or lowered for the seating configuration, the seat panel 150 is secured with respect to the right panel 120 and the left panel 130 through seat interlocks such as a tongue in groove, other notch, pin-based, and/or other support, for example. The seat panel 150 interacts with all three body panels 110-130 for increased seat stability, etc. To reattach or stow the seat panel 150 with respect to the storage door panel 140, the seat panel 150 is pushed up against the storage door panel 140 to engage the example mechanism 210-235 to removably attach the seat panel 150 to the storage door panel 140, for example. As such, the user does not need to actuate the lever 197 to secure the seat panel 150 to the storage door panel 140. Rather, the mechanism engages when the panels 140-150 are placed together to hold the seat panel 150 with respect to the storage door panel 140.

The seat panel 150 can include a pad or cover for added comfort to the user. In certain examples, the seat panel 150 has at least a portion formed of a lighter foam or other air-infused material to provide a cushion integrated in the seat panel 150, rather than a separate attachable part. The seat panel 150 is attached to the back of the center panel 110 via a hinge (e.g., piano hinge, door hinge, drop pin, living hinge, etc.), for example. FIG. 2B shows an example view of the latch 197 to actuate the pivot mechanism 210 in the seat panel 150.

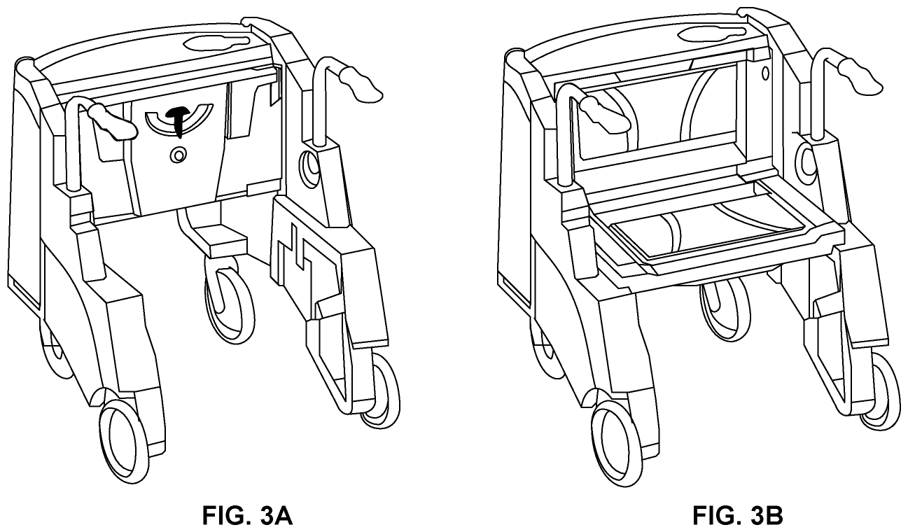

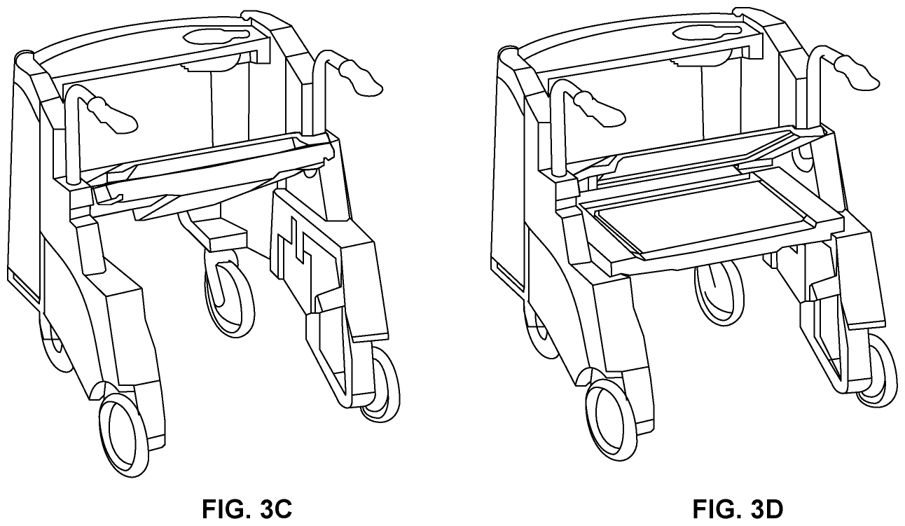

In certain examples, the storage door panel 140 includes magnets and/or interlock pins to hold itself in movable position with respect to the storage compartment 155 formed in the center panel 110. As such, the storage door panel 140 and the seat panel 150 can move together and/or independently into a variety of positions. FIGS. 3A-D illustrate an example sequence of configurations or modes including: all closed (FIG. 3A), seat down (FIG. 3B), storage open (FIG. 3C), and seat down with storage open (FIG. 3D). In the all-closed or mobility mode of FIG. 3A, a user is able to use the ambulation aid 100 to steady and support himself/herself walking, standing, etc. In the seated/seating mode of FIG. 3B, the user is able to utilize the seat panel 150 of the ambulation aid 100 to sit, for example. In the storage-accessible mode(s) of FIGS. 3C-D, a user can place or retrieve items from the storage compartment 155.

As such, when the apparatus 100 is in a closed/folded/transportation/storage configuration, the configuration can be maintained with a strap and/or other closure (e.g., Velcro®, etc.). Pulling the strap can release and begin to open the apparatus into the open configuration. Using one or more of the handles 160-165, the sides 120-130 can be unfolded and/or otherwise opened away from the center panel 110 and locked in place by moving the respective latches 190-195. The handles 160-165 can be moved toward each other to help ensure that the side panels 120-130 are securely latched with respect to the center panel 110. Brake levers 162-164 can be squeezed to engage the brake shoes 171-173 to slow the apparatus 100 or stop the apparatus 100 temporarily. Fully engaging each brake lever 162-164 locks the brake shoes 171-173 in place as a parking break for the apparatus 100. Actuating both brake levers 162-164 then disengages the brake shoes 171-173. Brake tension can be adjusted, such as by tightening or loosening a locking nut connected to the brake lever 162-164. Handle 160-165 height can also be adjusted.

FIG. 4 illustrates an example piano hinge 410 connecting the right panel 120 and the center panel 110. A similar hinge (not shown) can be used to connect the left panel 130 and the center panel 110. A different kind of hinge can be used in place of the piano hinge 410 shown as an example in FIG. 4. A latch mechanism 420 controlled by the latch 195 can be integrated into the panels 110, 120. When the panels 110, 120 are positioned in an open configuration, the latch 195 actuates the latch mechanism 420 to secure the right panel 120 with respect to the center panel 110 (and, similarly, the left panel 130 with respect to the center panel 110) in an open or mobility configuration.

FIG. 5A illustrates the example handle 165 positioned in the right panel 120 with a pin 510 in a channel 520. A position of the handle 165 in the channel 520 can be adjusted and secured by removing or pulling out the pin 510, positioning the handle 165 at a desired point in the channel 520, and then releasing or reinserting the pin 510 to lock the handle 165 in position.

FIG. 5B illustrates an alternative configuration of the handle 165 in which a clamp or lever 550 helps to hold the handle 165 in position. A similar configuration can be used with the handle 160. As shown in the example of FIG. 5B, to adjust a position of the handle 165, the clamp 550 is opened, and then the pin 510 can be removed and reinserted to position the handle 165 (and associated brake lever 164) at a desired position. The clamp 550 can then be re-engaged to help the pin 510 hold the handle 165 in position. As such, the clamp or lever 550 can help keep the handle 165 and brake lever 164 more secure.

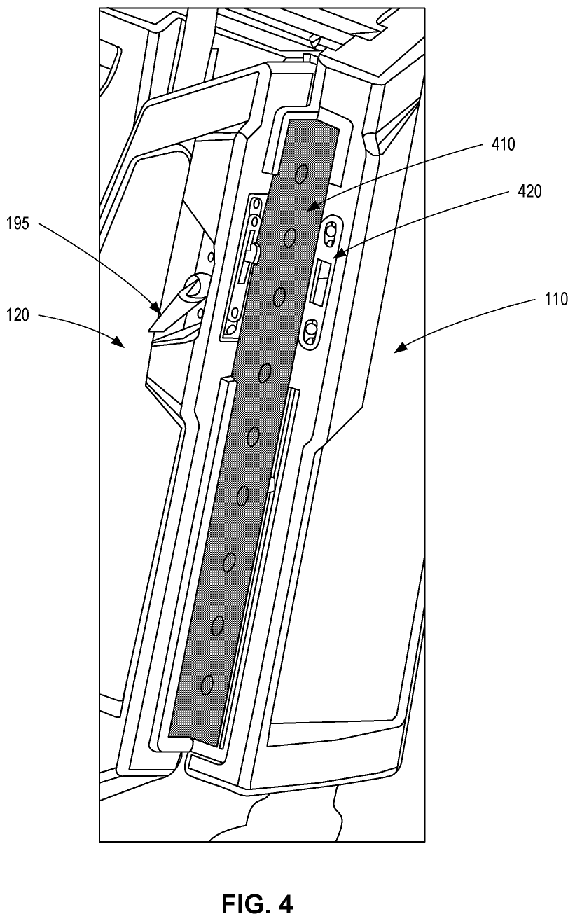

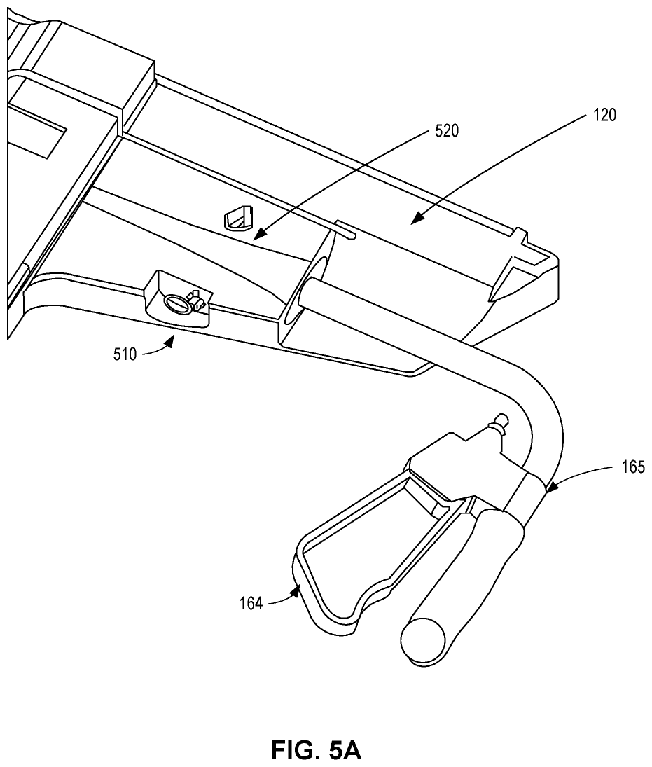

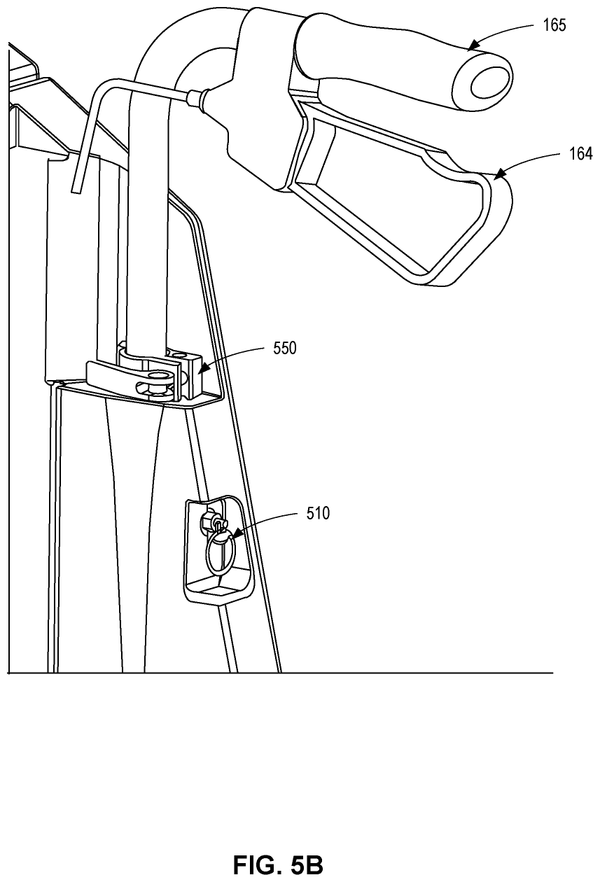

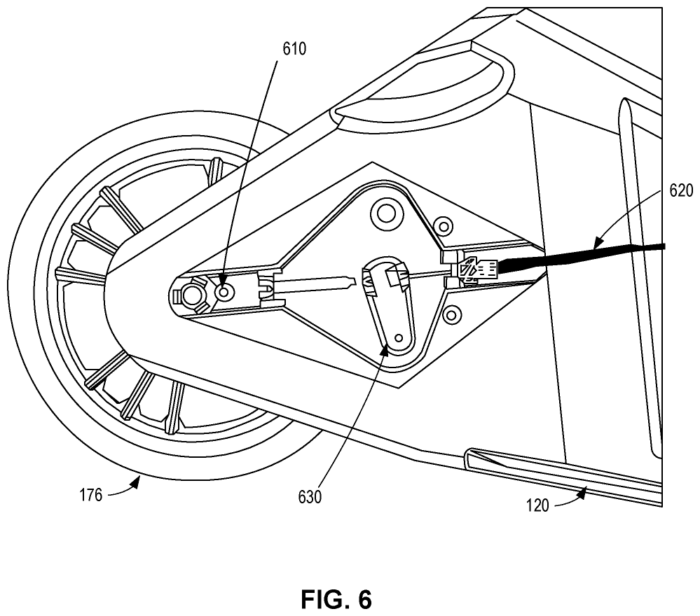

As shown in the example of FIG. 6, the handle 165 can be connected through the channel 520 to a brake 610 associated with the wheel 176 (or 170-174) using a cable 620. An actuation lever 630 triggers or activates the brake 610 when the handle 165 is squeezed or pulled, causing the cable 620 to pull the actuation lever 630 to trigger the brake 610. In certain examples, the brake 610 engages the corresponding brake shoe 171-173 (not visible in this view because it is located on the other side of the panel).

In certain examples, the handle 165 and/or the wheel 170-176 can be formed of foam or other air-infused material. In certain examples, the channel 520 can include a plurality of slots or openings to accommodate multiple heights or positions of the handle 165.

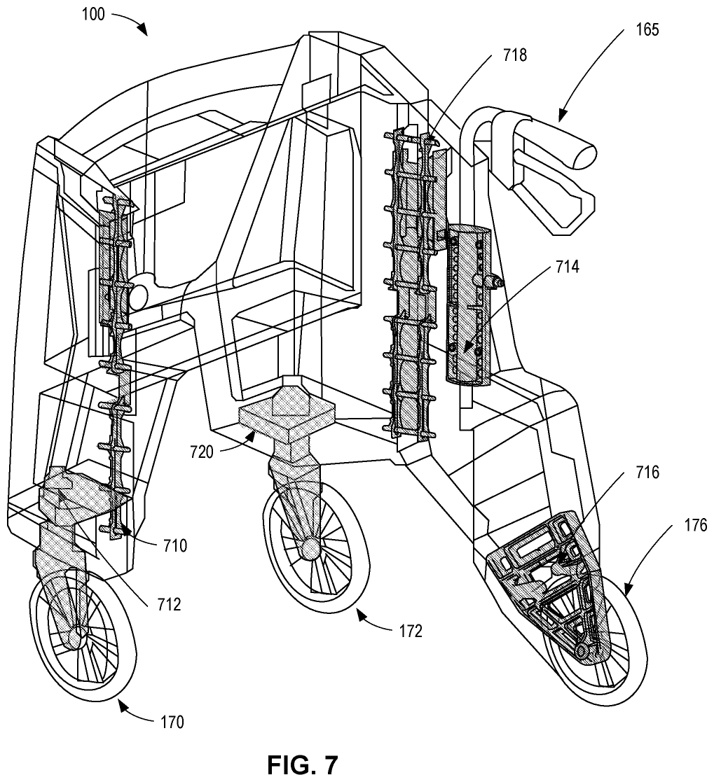

In certain examples, as described above, some or all of the elements of the example ambulation aid 100 can be formed of foam and/or other air-infused material using a process such as steam-chest molding, etc. In certain examples, such as shown in FIG. 7, attachment points or inserts 710-720, such as for wheel attachments, handle attachments, hinges, brakes, reinforcement, etc., can be provided as inserts around which the air-infused material forms the panels 110-150 as part of the steam-chest molding process to generate the ambulation aid 100. As such, inserts 710, 718 to strengthen one or more of the panels 110-150, and/or attachment points 712, 714, 716, 720 to connect attachments such as wheel 170-176, handle 160-165, etc., can be formed into the panels 110-150 of the apparatus 100.

### Example Methods of Manufacture

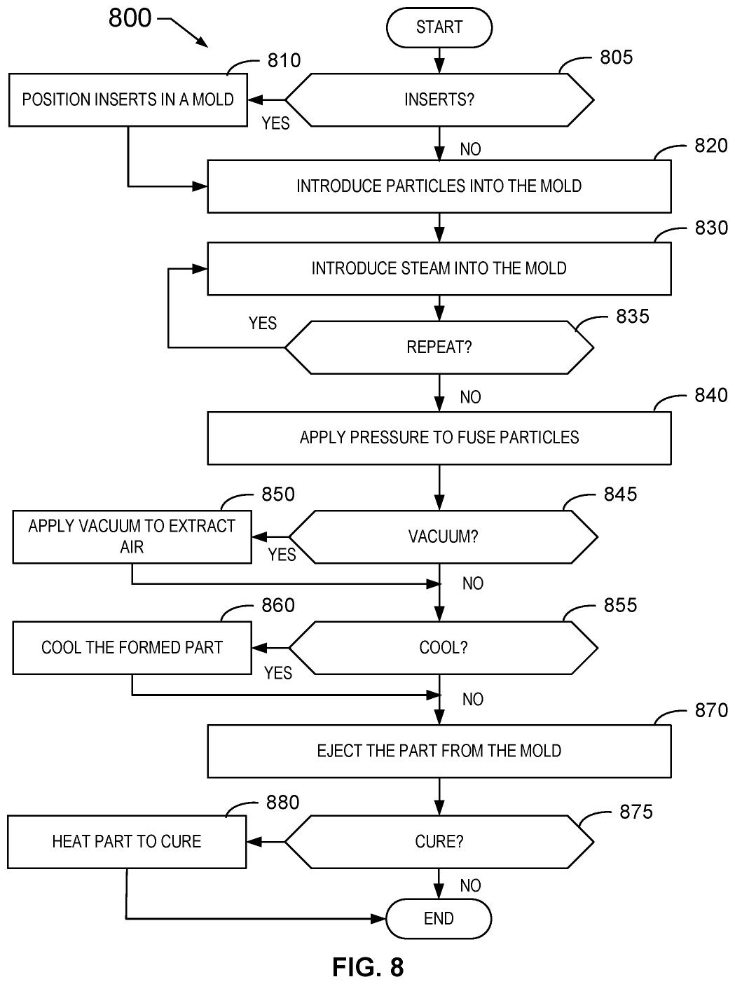

FIG. 8 illustrates a flow diagram of an example method 800 to manufacture an ambulation aid using steam-chest molding to form panels 110, 120, 130, 140, and/or 150 out of air-infused particles. The processing of the collection of air-infused particles (of one or more types) forms a foam or other air-infused material forming the panel(s) 110-150. In certain examples, the manufacturing process 800 can be used to separately implement the panels 110, 120, 130, 140, 150, which can then be combined using hinges, latches, other hardware, etc. In other examples, one or more of the panels 110-150 can be formed together, such as in a solid piece or in sections joined and formed together using a living hinge, flexible connection, etc.

In certain examples, one or more inserts such as reinforcement(s), attachment point(s), etc., can be formed in the panel(s) 110-150 through the manufacturing process 800 as well. Inserts can be provided individually within the mold to form the integral part. Alternatively or additionally, multiple inserts can be combined into a single insert structure provided in the mold to merge with the formed part.

Using an example steam-chest molding process 800, the ambulation aid 100 can be formed using beads, balls, or other particles (spherical and non-spherical) formed of a material, such as EPS, EPE, EPP, EPLA, ETPU, etc., forming a collection of particles having entrapped air (e.g., air-infused particles). When exposed to heat and/or pressure (e.g., steam, hot air, etc.), the particles combine to form a structure (e.g., a foam or other air-infused material structure constituting one or more structural panels 110-150 of the example ambulation aid 100). In certain examples, the plurality of particles are of the same composition. In other examples, a mixture of different particles having entrapped air is used to provide different properties to some or all of the part(s) being formed. For example, reinforcement, coloration, etc., can be provided through a combination of particles fused to form the panel(s) 110-150.

The example process 800 leverages a manufacturing or forming apparatus (e.g., a steam-chest molding machine or apparatus) including a mold and associated assembly. The example mold includes vents integrated into the surface(s) of the mold to facilitate introduction and evacuation of steam, pressure, etc. The mold can be associated with injectors to provide particles, steam, pressure, etc., and ejectors to eject the part after molding is complete. In certain examples, the formed part can be cured in an oven or other heated chamber.

At block 805, a plan, schematic, design file, setting, or other configuration of the process 800 and/or associated steam-chest molding machine is evaluated to determine whether one or more inserts are to be incorporated into the formed part. When one or more inserts 710-720 are to be included, then, at block 810, the one or more inserts 710-720 are positioned in a mold. For example, inserts 710-720, such as reinforcements, supports, hinges, magnets, latches, interlock pins, and/or other attachment points (e.g., for wheels, handles, trays, other accessories, etc.) are positioned in a mold. Such inserts 710-720 can be held in position using the mold, using a support structure (e.g., that can later be snapped or machined off of the resulting part), etc. One or more individual inserts 710-720 can be positioned in the mold and/or an integrated or composite insert formed of multiple attachment points, reinforcements, etc., as a single piece can be positioned in the mold for formation into the resulting part.

The mold can be configured to make individual panels 110-150 and/or collections of one or more connected panels 110-150 (e.g., connected using a living hinge, etc.). Deeper areas of the mold accommodate more material and result in thicker portions, while shallower areas of the mold result in thinner portions or sections of the part. As such, the mold can accommodate thicker, structural panels 110-150 (or portion(s)/section(s) of a panel 110-150) as well as thinner connecting regions, panel 110-150 portion(s), etc., in a single mold in a single execution of the process 800. In certain examples, rather than directly forming one or more parts of the example ambulation aid 100, the mold can be configured to form a block of air-infused material from which one or more parts of the ambulation aid 100 will be cut or otherwise extracted.

At block 820, a collection or stream of air-infused particles is introduced into the mold. For example, a collection of particles having entrapped air (also referred to as air-infused particles) such as EPS, EPE, EPP, EPLA, and/or ETPU beads/spheres, composite particles with air, particles with internal pressure, expandable composite particles, etc., are introduced into the mold at a certain volume. In certain examples, the mold is opened (e.g., by a motor, etc.) to allow the collection of particles to be introduced to a cavity of the mold (e.g., automatically be motor, manually, etc.). Once the desired or specified volume of particles has been introduced into the mold, the mold is closed (e.g., by a motor, etc.). For example, two portions of the steam-chest molding apparatus separate (e.g., using a motor, other force, etc.) to reveal an open cavity in which particles, insert(s), etc., can be placed. The two portions then converge (e.g., using the motor, other force, etc.) to enclose the particles, etc., in the cavity inside the manufacturing or forming apparatus. In certain examples, pressure is applied to the collection of particles inside the mold by the closure of the mold on the particles. In other examples, a flow of air-infused particles is introduced into the mold via vents or channels from a container by an injector to fill the mold with the collection of air-infused particles (along with any insert(s) previously positioned in the mold cavity).

At block 830, steam is introduced into the mold. For example, one or more valves open in the steam-chest molding apparatus to introduce steam into the mold cavity that includes the particles, etc. When exposed to the steam, the particles in the mold transition to a fusible state. In certain examples, the air-infused particles expand when exposed to the steam. In other examples, the size of the air-infused particles remains consistent under exposure to the steam. Steaming of the particles in the mold can include heating of the mold to maintain a desired temperature, for example.

At block 835, the plan, schematic, design file, setting, or other configuration of the process 800 and/or associated steam-chest molding machine is evaluated to determine whether the steaming of the mold is to be repeated. In some examples, the steaming of the particles in the mold is repeated so that the steam is introduced from both ends of the mold. In other examples, only one exposure to steam is sufficient to prepare the particles for fusing.

When steaming is to be repeated, then block 830 is repeated one or more times before proceeding to block 840. For example, a mold can be cross-steamed from multiple valves providing flow of steam, air, etc., to the mold. In certain examples, the steaming process includes purging the mold, cross-steaming the particles in the mold, and autoclave steaming, for example. The steaming process transitions the particles in the mold to a state (e.g., in which the particles are molten and/or softened) in which the particles can be fused.

At block 840, pressure is applied to fuse the particles into an integral part. For example, the collection of molten/softened particles is fused and/or welded together through interconnections between the particles in the heated, pressurized environment of the mold. In certain examples, pressure applied to the particles can vary based on a desired density of the resulting integral part. For example, lighter pressure results in a less dense foam or other air-infused material, while heavier pressure forms a more dense structure. In certain examples, some or all of the air-infused particles are infused with internal pressure to aid in the fusion of particles. In other examples, density is determined by construction and/or composition of the particles, rather than a degree of applied pressure. In certain examples, a concentration or packing of the particles in the mold initially affects a resulting density of the formed part. In certain examples, a closing of the mold applies a pressure that compresses the particles inside the mold at an increased density.

As the air-infused particles combine under steam and pressure, the resulting air-infused material forms around any insert(s) previously inserted in the mold. As such, an attachment point for the tray 180, seat panel 150, storage door panel 140, handle 160-165, etc., can be integrated into one or more panels 110-150 forming the body of the ambulation aid 100 in the steam-chest molding process, for example.

In certain examples, pressure applied in the mold to form the integral part also creates a barrier or “skin” on the exterior portion of the part (e.g., the portion(s) of the air-infused material contacting the interior surface of the closed mold). The skin provides a barrier against the entry of moisture into the formed part and provides added rigidity to the integral part without necessitating a coating of additional material, for example.

In certain examples, the steaming (block 830) and pressurization (block 840) are combined to introduce steam under pressure through one or more valves into the mold to heat the particles under pressure, resulting in a formed mass of air-infused material forming a part (e.g., an integral part of the ambulation aid 100 such as one or more panels 110-150, accessories such as handle 160-165, wheel 170-176, brake 171-173, 610, etc.).

At block 845, the plan, schematic, design file, setting, or other configuration of the process 800 and/or associated steam-chest molding machine is evaluated to determine whether vacuum is to be applied. When vacuum is to be applied, at block 850, vacuum is used to extract air and/or steam remaining in the mold. For example, leftover air remaining after the fusing may cause unwanted bubbles or pockets to form in the part. As such, the air can be removed to preserve the integrity of the part.

At block 855, the plan, schematic, design file, setting, or other configuration of the process 800 and/or associated steam-chest molding apparatus is evaluated to determine whether the mold is to be cooled. When cooling is to be applied, at block 860, the formed part (e.g., one or more of the panels 110-150 and associated insert(s), etc.) can be cooled. For example, cooling air, cooling water, etc., can be introduced into and/or around the mold to cool and cure the formed part of air-infused material (e.g., foam, etc.). In certain examples, an exterior of the mold is cooled, rather than the part in the mold. Pressure can be maintained until the part is cured to avoid unwanted expansion or bloating of the part during cooling and curing. Any cooling liquid, if used, is ejected from the mold. In certain examples, the part can be allowed to air cool or otherwise gradually cool rather than using cooling air or liquid.

At block 870, the formed part can be ejected or otherwise removed from the opened mold. For example, the two portions of the steam-chest machine can be opened (e.g., by motor) to reveal the formed part, and an ejector can push the part out of the mold.

At block 875, the plan, schematic, design file, setting, or other configuration of the process 800 and/or associated steam-chest machine is evaluated to determine whether the part is to be further cured. When the part is to be further cured, at block 880, the part is heated to cure the part. For example, the part can be heated in an oven, autoclave, etc., to cure the part. In some examples, the part remains in the mold to be cured before removal.

In certain examples, other post-processing (e.g., polishing, machining, painting, etc.) can be applied to the finished part. In certain examples, one or more attachments, accessories, etc., that were separately formed (e.g., by steam-chest molding, injection molding, additive manufacturing, milling, etc.) can be attached to the formed part at the one or more attachment points that have been formed integral to the part, for example.

While the example of FIG. 8 depicts a sequence of actions in a certain order, the blocks of FIG. 8 can be executed in a different order to form part(s) of the ambulation aid 100. One or more blocks can be interchanged, combined, removed, repeated, etc., to form one or more integral parts such as one or more panels 110-150 of the example ambulation aid 100.

Thus, a monolithic part can be formed as the body of the ambulation aid 100. In certain examples, the part is of uniform density. In other example, density of the part varies throughout as stiffeners, reinforcements, attachment points, etc., increase the density of the part at various locations. Inserts, attachment points, etc., can be injected molded and then inserted into the steam chest mold to be integrated into the steam chest molded body of the ambulation aid, for example. As such, the steam-chest molded foam or other air-infused material can be lightweight, strong, durable, semi-rigid, etc., while plastic insert(s) are rigid, rubber insert(s) are flexible, etc. Inserts, additives, etc., introduce different material property(-ies) than the material provides.

### Example Ornamental Designs

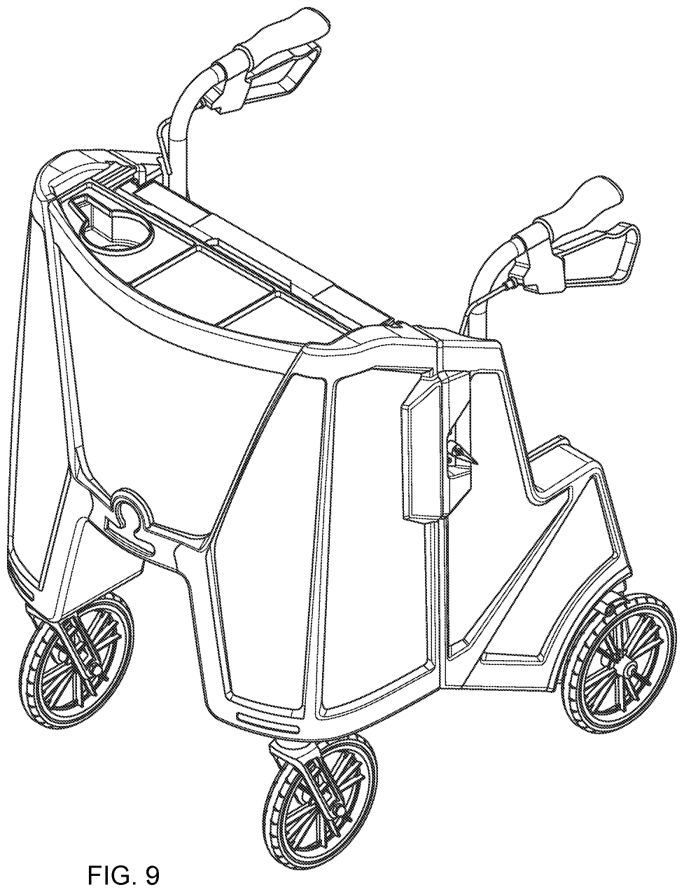

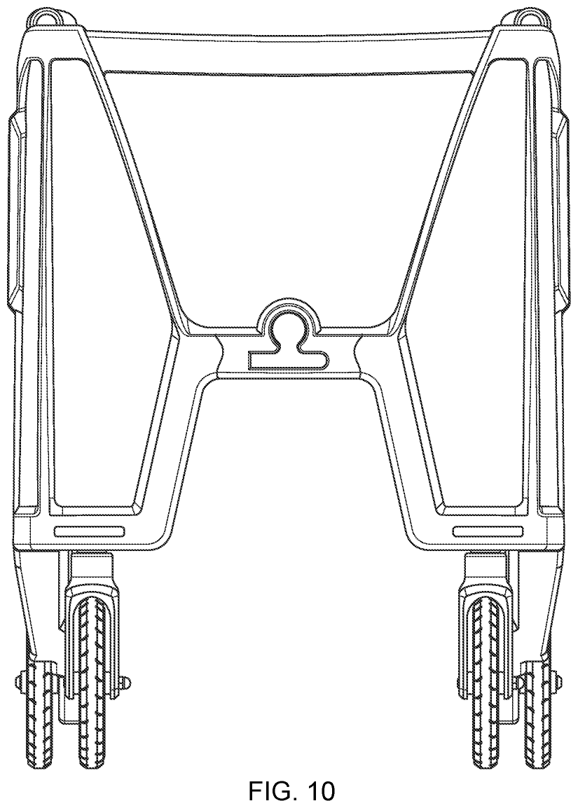

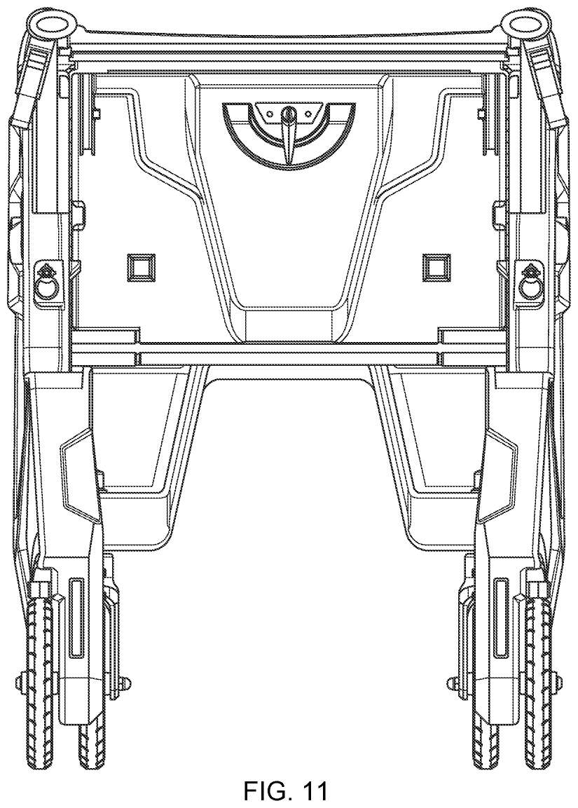

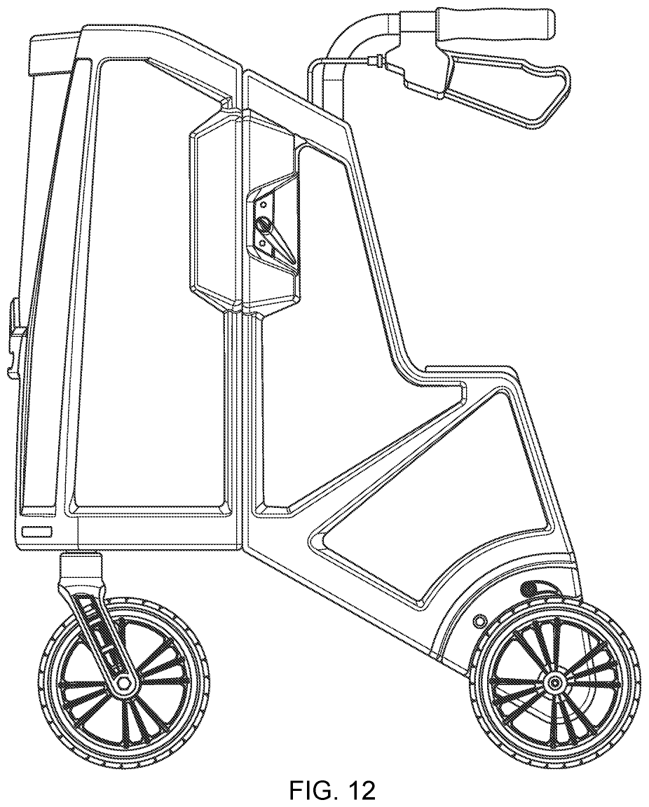

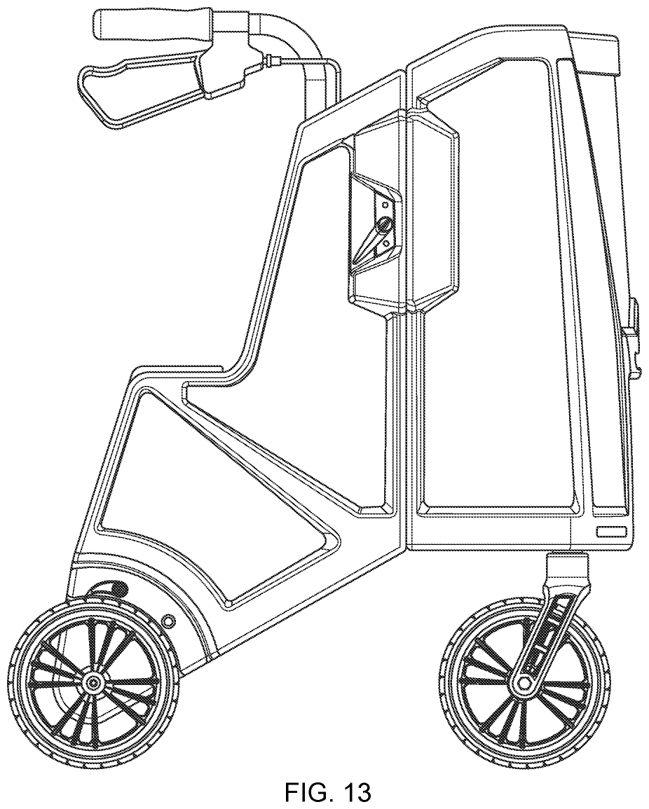

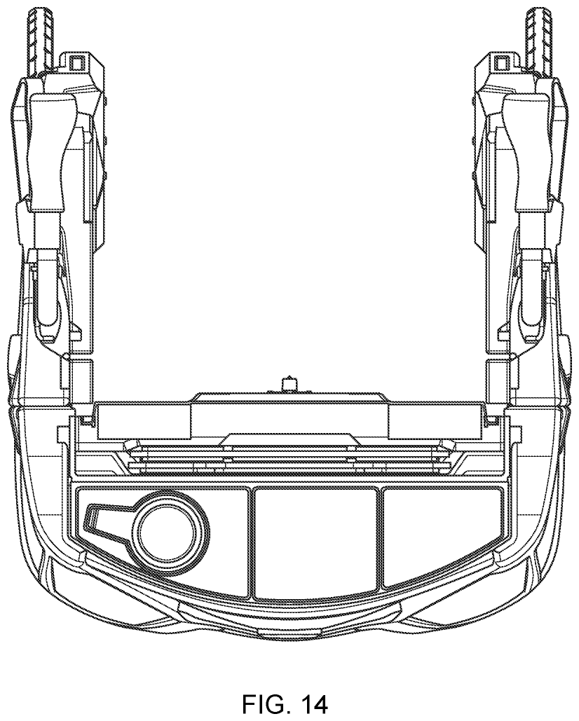

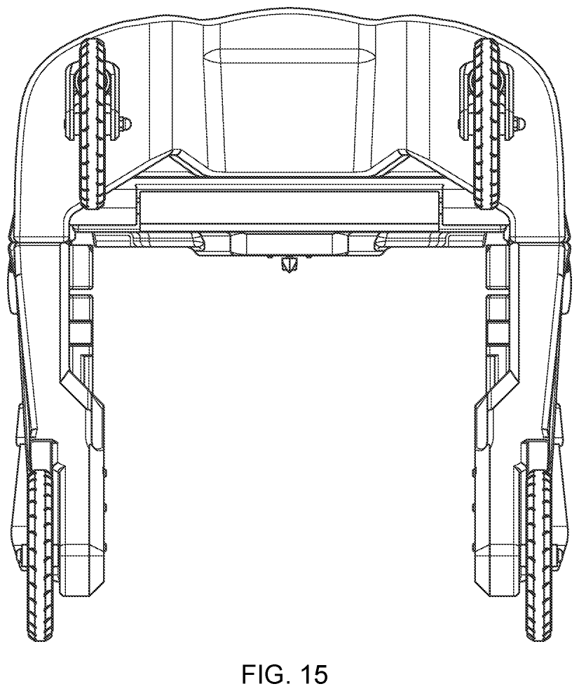

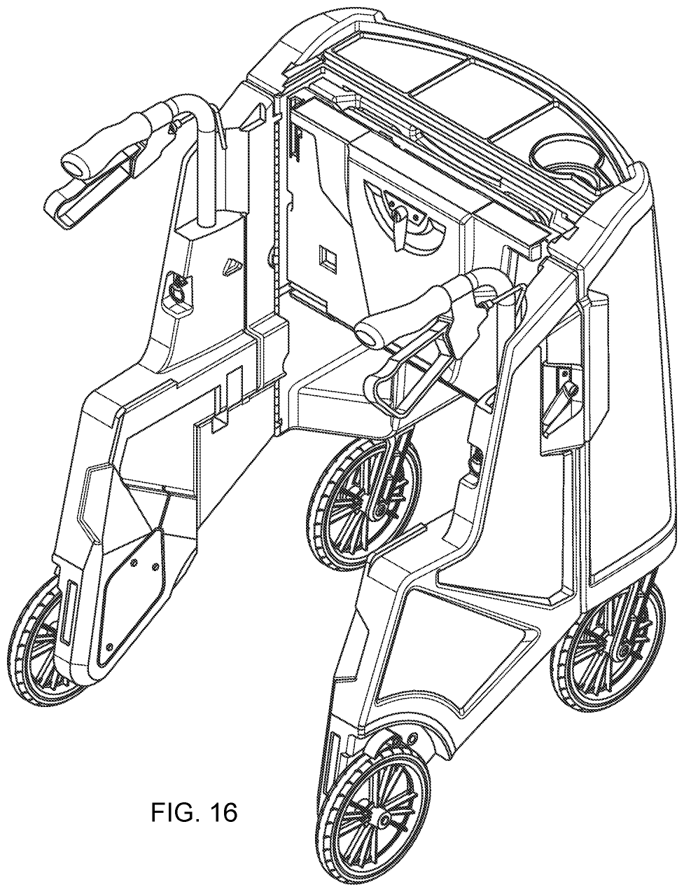

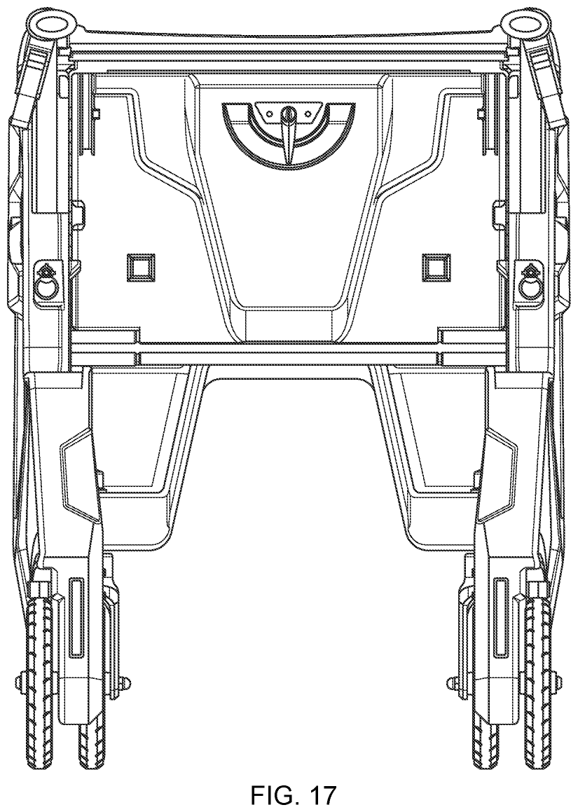

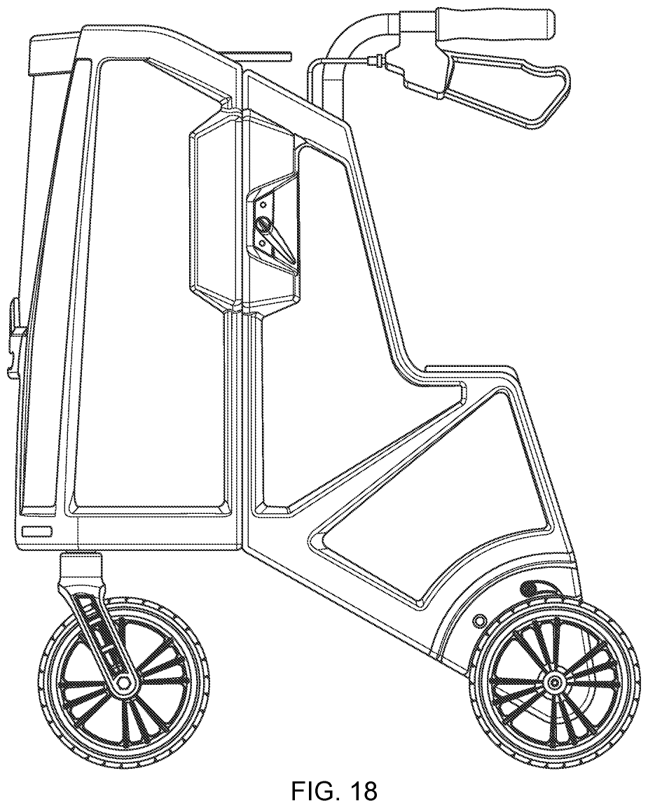

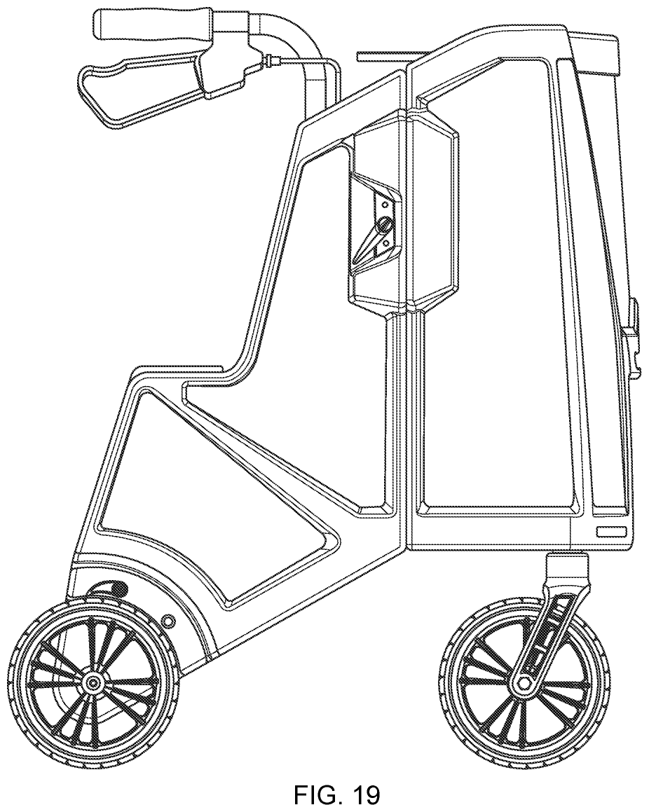

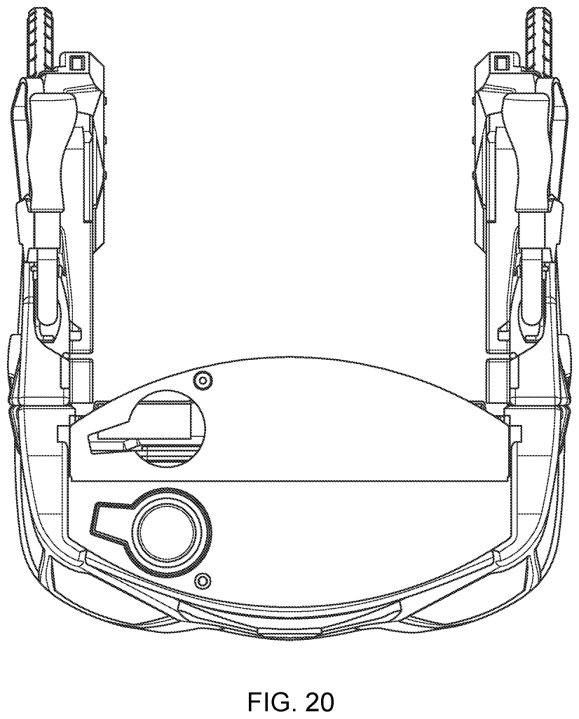

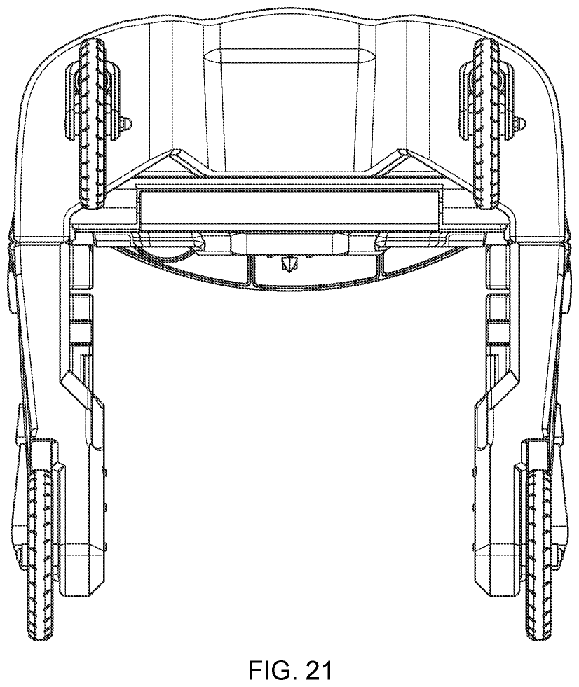

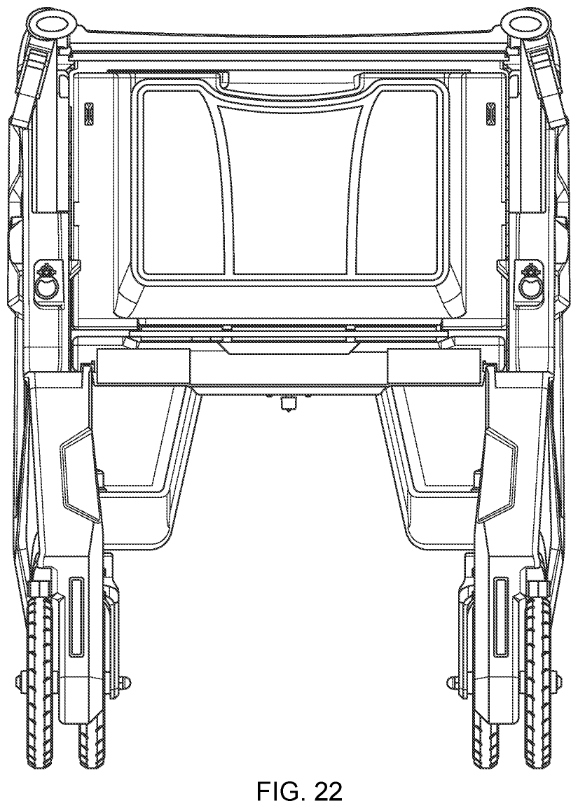

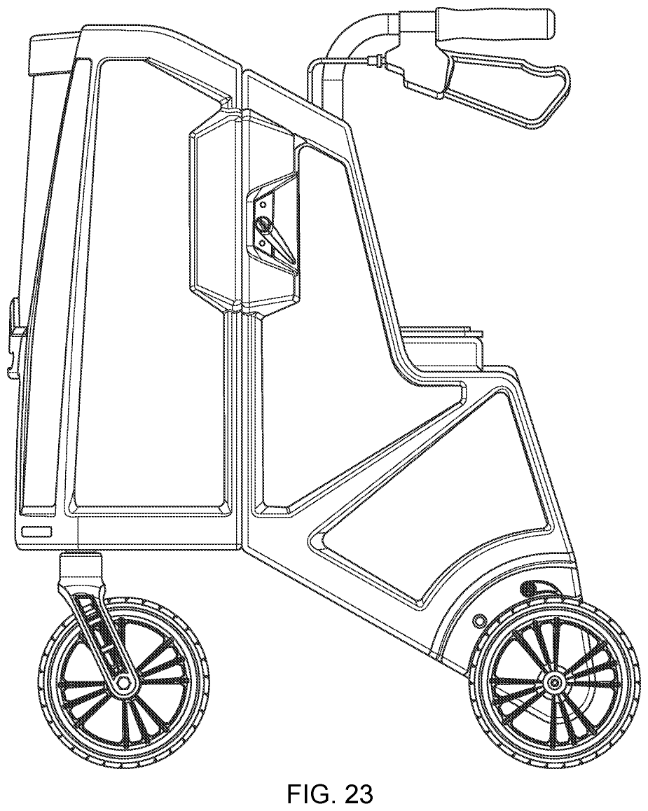

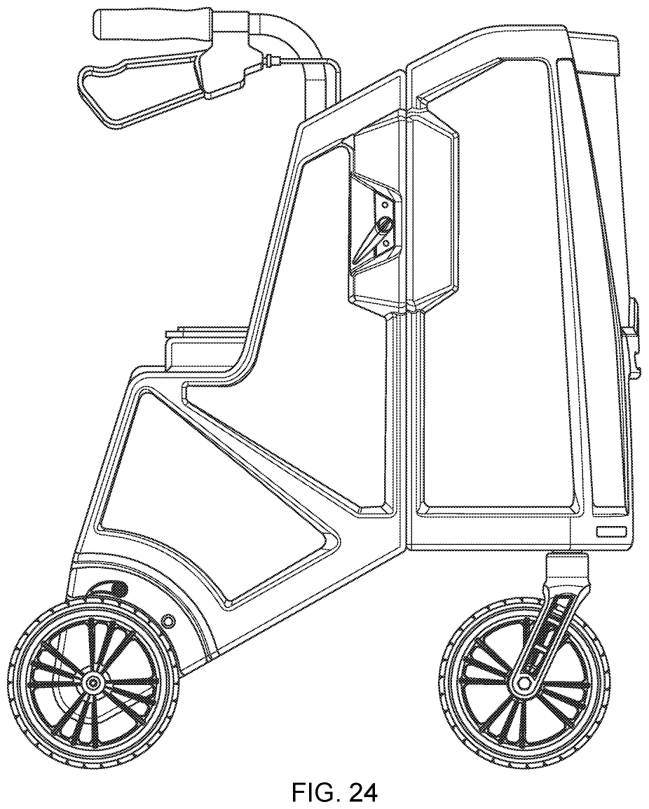

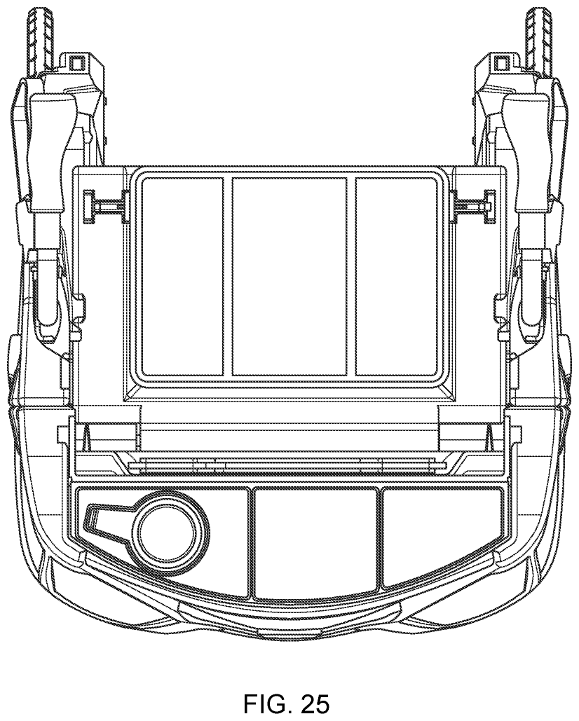

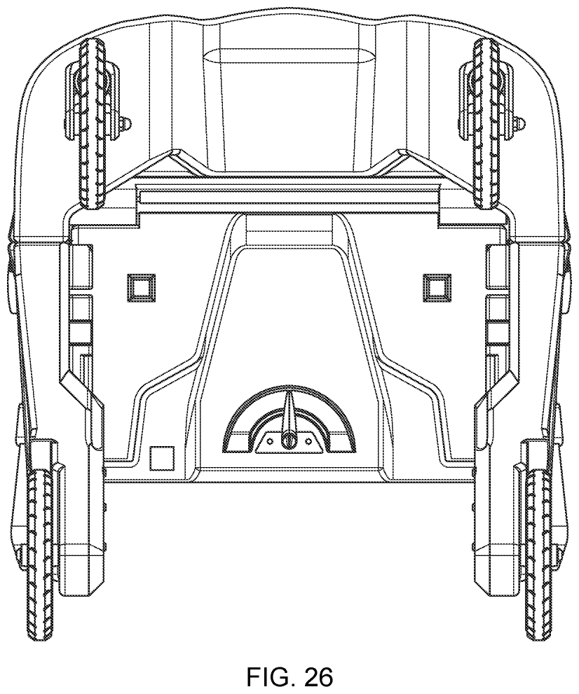

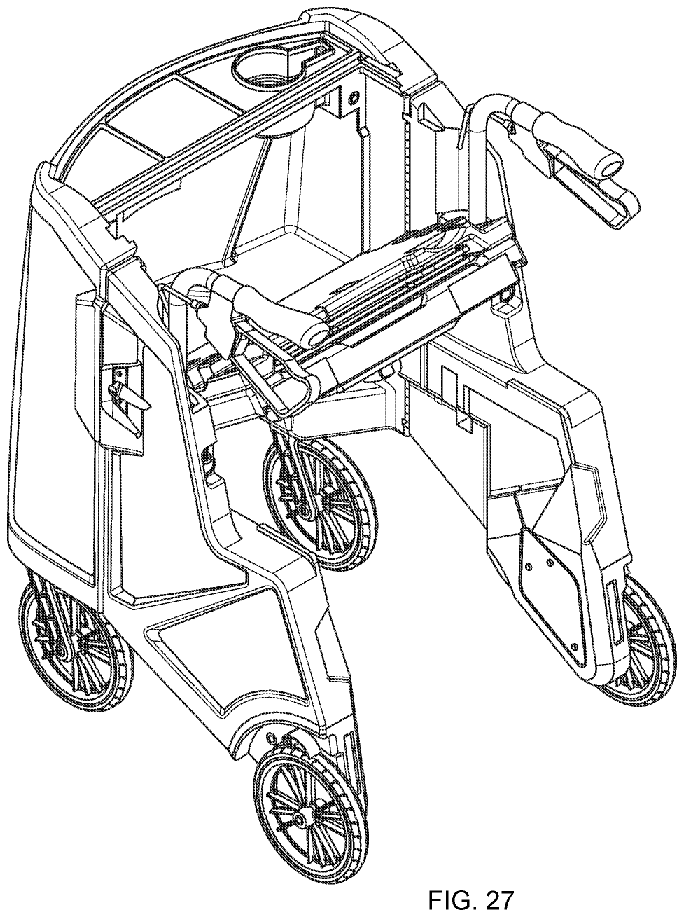

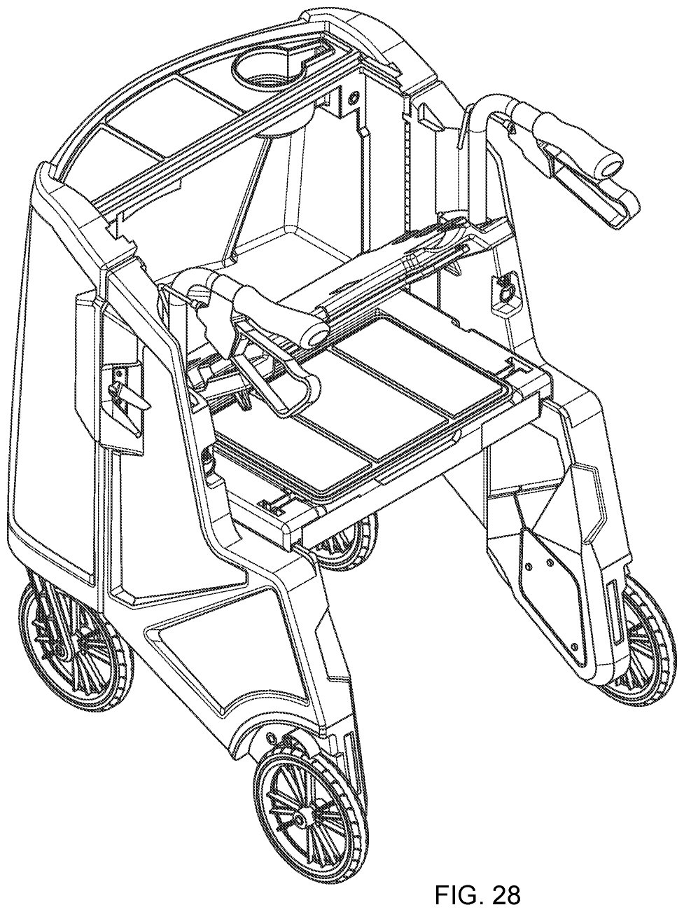

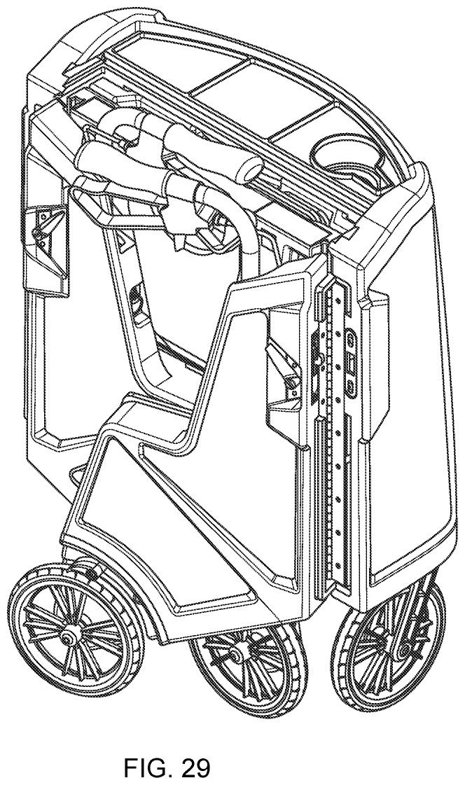

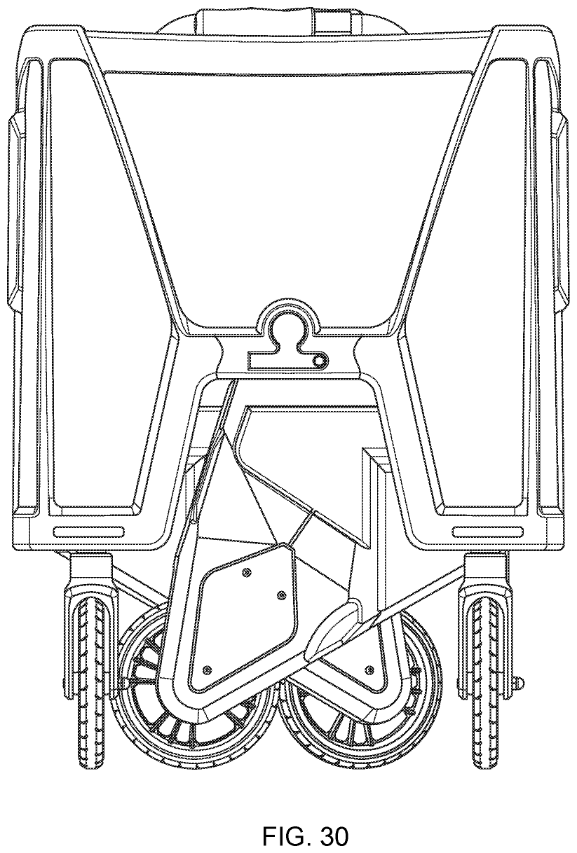

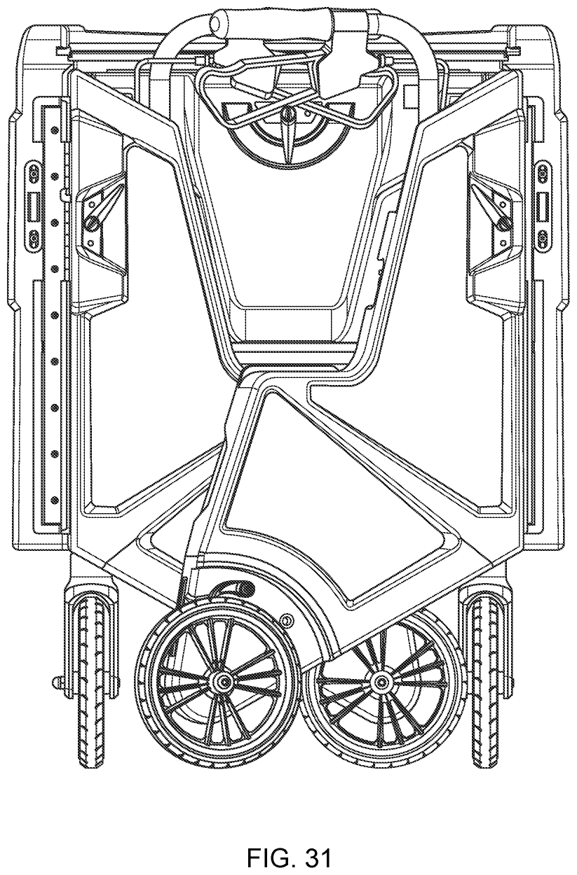

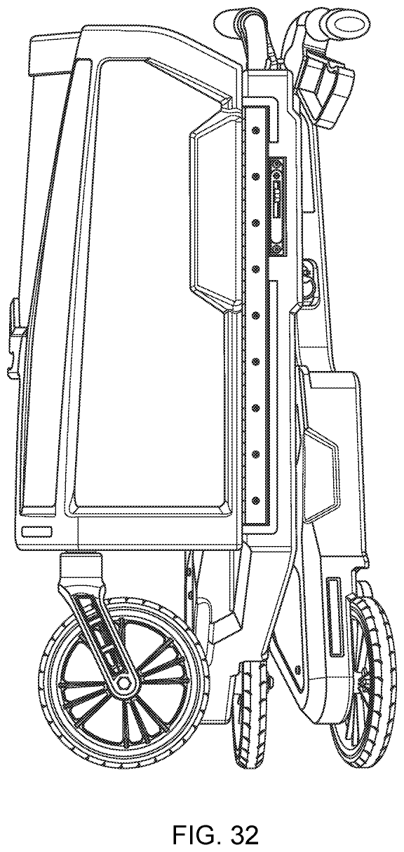

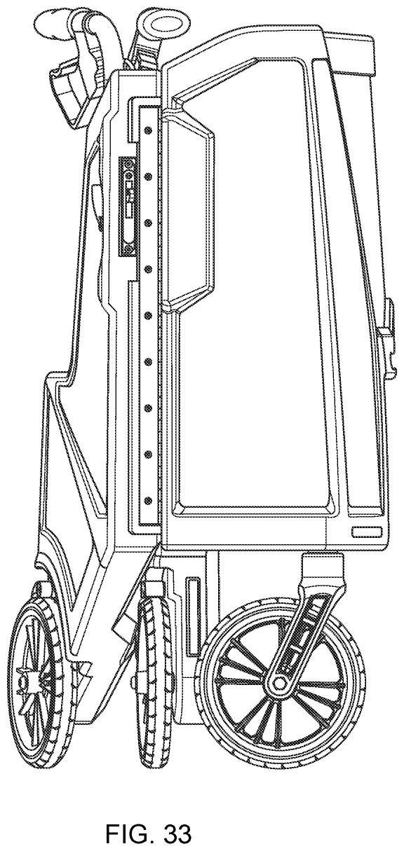

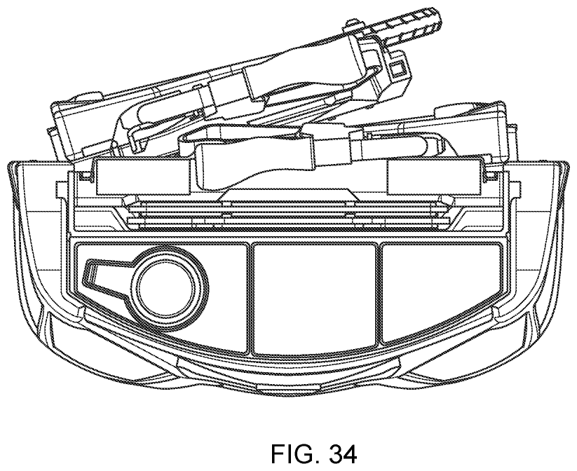

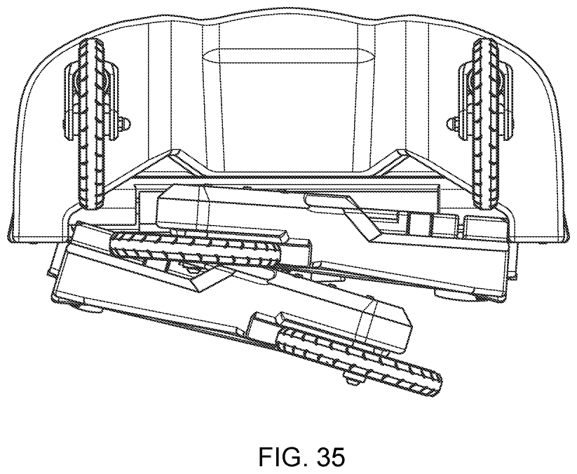

FIGS. 9-35 illustrate a plurality of views of an ornamental appearance of an example ambulation aid.

Further aspects of the present disclosure are provided by the subject matter of the following clauses:
Example 1 is an ambulation aid apparatus including: a first panel; a second panel; and a third panel, the second panel and the third panel interconnected on opposite sides of the first panel and positionable to support a user, the first panel, the second panel, and the third panel formed of a fused collection of air-infused particles.
Example 2 is the ambulation aid apparatus of any preceding clause, wherein at least one of the first panel, the second panel, and the third panel is formed from steam-chest molding of particles.
Example 3 is the ambulation aid apparatus of any preceding clause, wherein at least two of the first panel, the second panel, and the third panel are at least one of formed together or connected using a living hinge.
Example 4 is the ambulation aid apparatus of any preceding clause, wherein one or more inserts are formed inside one or more of the first, second, and third panels to form at least one of attachment points and reinforcement points.
Example 5 is the ambulation aid apparatus of any preceding clause, further including one or more handles attachable to one or more of the first, second, and third panels via the attachment points.
Example 6 is the ambulation aid apparatus of any preceding clause, further including one or more wheels with brakes attachable to one or more of the first, second, and third panels via the attachment points.
Example 7 is the ambulation aid apparatus of any preceding clause, further including a seat panel movable with respect to a back side of the first panel, the seat panel interlocking with the first, second, and third panels in a down position to support a user.
Example 8 is the ambulation aid apparatus of any preceding clause, wherein the seat panel is formed of air-infused particles.
Example 9 is the ambulation aid apparatus of any preceding clause, further including a storage door panel enclosing a storage compartment formed in the first panel, the storage door panel movable with respect to the first panel to expose the storage compartment at a first position and enclose the storage compartment at a second position.
Example 10 is the ambulation aid apparatus of any preceding clause, wherein the seat panel is removably attachable to the storage door panel.
Example 11 is the ambulation aid apparatus of any preceding clause, wherein the seat panel and the storage door panel are movable both individually and when attached together.
Example 12 is the ambulation aid apparatus of any preceding clause, wherein the storage door panel is formed of air-infused particles.
Example 13 is the ambulation aid apparatus of any preceding clause, wherein the fused collection of air-infused particles with entrapped air includes a plurality of spheres formed of at least one of expandable polystyrene (EPS), expanded polyethylene (EPE), expanded polypropylene (EPP), expanded polylactide (EPLA), or expanded thermoplastic polyurethane (ETPU) for steam-chest molding.
Example 14 is a method of manufacturing an ambulation aid, the method including: molding a first panel of air-infused particles; molding a second panel of air-infused particles; molding a third panel formed of air-infused particles; and movably affixing the second panel and the third panel on opposite sides of the first panel, wherein the second panel and the third panel are interconnected on opposite sides of the first panel and positionable to support a user.
Example 15 is a method of manufacturing an ambulation aid, the method including: introducing a plurality of particles having entrapped air into a mold; introducing steam into the mold to fuse the plurality of particles within the mold; and applying pressure to fuse the plurality of particles into an ambulation aid panel.
Example 16 is the method of any preceding clause, further including applying a vacuum to extract air from the mold.
Example 17 is the method of any preceding clause, further including cooling the ambulation aid panel in the mold.
Example 18 is the method of any preceding clause, further including introducing an insert in the mold, wherein introducing steam and applying pressure fuse the plurality of particles into the ambulation aid panel including the insert.
Example 19 is the method of any preceding clause, wherein the insert includes at least one of a reinforcement, an attachment point, or a hinge.
Example 20 is the method of any preceding clause, wherein the ambulation aid panel includes one or more of a center panel, a left panel, or a right panel.
Example 21 is the method of any preceding clause, wherein the ambulation aid panel includes the center panel, the left panel, and the right panel interconnected with living hinges.
Example 22 is an ambulation aid apparatus including: a panel formed of a collection of fused particles with entrapped air forming an integral part to support mobility of a user, the panel including at least one attachment point formed integral to the panel; and at least one of a wheel or a handle connected to the panel at the at least one attachment point.
Example 23 is an ambulation aid apparatus formed of a collection of fused particles with entrapped air.
Example 24 is the ambulation aid apparatus of any preceding clause formed as a cane. Example 25 is the ambulation aid apparatus of any preceding clause formed as a crutch. Example 26 is the ambulation aid apparatus of any preceding clause formed as a walker.

Modifications and variations as would be apparent to a skilled addressee are determined to be within the scope of the present invention.

It is to be understood that, if any prior art is referred to herein, such reference does not constitute an admission that the prior art forms a part of the common general knowledge of the art in any country.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

1. An ambulation aid apparatus comprising:
a first panel;
a second panel; and
a third panel,
the second panel and the third panel interconnected on opposite sides of the first panel and positionable to support a user,
the first panel, the second panel, and the third panel formed of a fused collection of air-infused particles.

2. The ambulation aid apparatus of claim 1, wherein at least one of the first panel, the second panel, and the third panel is formed from steam-chest molding of particles.

3. The ambulation aid apparatus of claim 1, wherein at least two of the first panel, the second panel, and the third panel are at least one of formed together or connected using a living hinge.

4. The ambulation aid apparatus of claim 1, wherein one or more inserts are formed inside one or more of the first, second, and third panels to form at least one of attachment points and reinforcement points.

5. The ambulation aid apparatus of claim 4, further including one or more handles attachable to one or more of the first, second, and third panels via the attachment points.

6. The ambulation aid apparatus of claim 4, further including one or more wheels with brakes attachable to one or more of the first, second, and third panels via the attachment points.

7. The ambulation aid apparatus of claim 1, further including a seat panel movable with respect to a back side of the first panel, the seat panel interlocking with the first, second, and third panels in a down position to support a user.

8. The ambulation aid apparatus of claim 7, wherein the seat panel is formed of air-infused particles.

9. The ambulation aid apparatus of claim 7, further including a storage door panel enclosing a storage compartment formed in the first panel, the storage door panel movable with respect to the first panel to expose the storage compartment at a first position and enclose the storage compartment at a second position.

10. The ambulation aid apparatus of claim 9, wherein the seat panel is removably attachable to the storage door panel.

11. The ambulation aid apparatus of claim 10, wherein the seat panel and the storage door panel are movable both individually and when attached together.

12. The ambulation aid apparatus of claim 9, wherein the storage door panel is formed of air-infused particles.

13. The ambulation aid apparatus of claim 1, wherein the fused collection of air-infused particles with entrapped air includes a plurality of spheres formed of at least one of expandable polystyrene (EPS), expanded polyethylene (EPE), expanded polypropylene (EPP), expanded polylactide (EPLA), or expanded thermoplastic polyurethane (ETPU) for steam-chest molding.

14. A method of manufacturing an ambulation aid, the method comprising:
molding a first panel of air-infused particles;
molding a second panel of air-infused particles;
molding a third panel formed of air-infused particles; and
movably affixing the second panel and the third panel on opposite sides of the first panel,
wherein the second panel and the third panel are interconnected on opposite sides of the first panel and positionable to support a user.

15. A method of manufacturing an ambulation aid, the method comprising:
introducing a plurality of particles having entrapped air into a mold;
introducing steam into the mold to fuse the plurality of particles within the mold; and
applying pressure to fuse the plurality of particles into an ambulation aid panel.

16. The method of claim 15, further including applying a vacuum to extract air from the mold.

17. The method of claim 15, further including cooling the ambulation aid panel in the mold.

18. The method of claim 15, further including introducing an insert in the mold, wherein introducing steam and applying pressure fuse the plurality of particles into the ambulation aid panel including the insert.

19. The method of claim 18, wherein the insert includes at least one of a reinforcement, an attachment point, or a hinge.

20. The method of claim 15, wherein the ambulation aid panel includes one or more of a center panel, a left panel, or a right panel.

21-26. (canceled)
